(19) United States
(12) Patent Application Publication
(10) Pub. No.: US 2016/0011971 A1
(43) Pub. Date: Jan. 14, 2016

(54) STORAGE MEDIUM, MEMORY SYSTEM, AND METHOD OF MANAGING STORAGE AREA IN MEMORY SYSTEM

(71) Applicants: Jae-il LEE, Hwaseong-si (KR); Geun-soo KIM, Suwon-si (KR); Jae-hoon HEO, Suwon-si (KR); Du-won HONG, Osan-si (KR); Moon-wook OH, Seoul (KR)

(72) Inventors: Jae-il LEE, Hwaseong-si (KR); Geun-soo KIM, Suwon-si (KR); Jae-hoon HEO, Suwon-si (KR); Du-won HONG, Osan-si (KR); Moon-wook OH, Seoul (KR)

(21) Appl. No.: 14/751,800

(22) Filed: Jun. 26, 2015

(30) Foreign Application Priority Data
Jul. 14, 2014 (KR) 10-2014-0088454

(51) Int. Cl. G06F 12/02

(52) U.S. Cl. CPC G06F 12/0246; G06F 2212/7201

(57) ABSTRACT

A method of managing a storage area of a memory device in a memory system is provided. A first data is received. The first data has a logical address to be written to the memory device having a plurality of memory blocks. The first data is classified into one of a hot data and a cold data based on an update frequency of the first data. A memory block is defined into a first storage area and a second storage area based on an amount of charge loss of a memory cell in the memory block. A memory cell of the first storage area has charge loss greater than a memory cell of the second storage area. The logical address of the first data is converted to a physical address of the memory device according to a result of the classifying of the first data. The first data is written to a memory cell having the physical address of the memory device.

### CROSS-REFERENCE TO RELATED APPLICATION

This application claims priority under 35 U.S.C. §119 to Korean Patent Application No. 10-2014-0088454, filed on Jul. 14, 2014 in the Korean Intellectual Property Office, the disclosure of which is incorporated by reference herein in its entirety.

### TECHNICAL FIELD

The inventive concept relates to a storage medium, a memory system, and a method of managing a storage area in the memory system.

### DISCUSSION OF RELATED ART

A non-volatile memory device is a memory device capable of retaining stored information without power supply. An example of the non-volatile memory device is a flash memory device. Charge loss behavior tends to vary according to storage locations of a non-volatile memory device. Accordingly, reading performance is degraded in a storage location with poor charge loss behavior.

### SUMMARY

According to an exemplary embodiment of the present inventive concept, a method of managing a storage area of a memory device in a memory system is provided. A first data is received. The first data has a logical address to be written to the memory device having a plurality of memory blocks. The first data is classified into one of a hot data and a cold data based on an update frequency of the first data. A memory block is defined into a first storage area and a second storage area based on an amount of charge loss of a memory cell in the memory block. A memory cell of the first storage area has charge loss greater than a memory cell of the second storage area. The logical address of the first data is converted to a physical address of the memory device according to a result of the classifying of the first data. The first data is written to a memory cell having the physical address of the memory device.

According to an exemplary embodiment of the present inventive concept, a memory system includes a memory device and a memory controller. The memory device includes a plurality of memory blocks. A memory block includes a first storage area including a first memory cell and a second storage area including a second memory cell. A memory controller classifies data to be written to the memory device into one of a hot data and a cold data based on an update frequency of the data. The first storage area and the second storage area are determined based on an amount of charge loss of the first and second memory cells according to time. The amount of charge loss of the first memory cell is greater than the amount of charge loss of the second memory cell.

According to an exemplary embodiment of the present inventive concept, a method of managing a storage area of a memory device in a memory system is provided. A first data to be written to the storage area is classified into one of a hot data and a cold data based on a predetermined criteria. A first storage area and a second storage area of a memory Hock of the plurality of memory blocks is defined according to locations of a plurality of memory cells in the memory block. If a first result of the classifying of the first data indicates to a cold data, the first data is written into the second storage area of the memory block. If a second result of the classifying of the first data indicates a hot data and if the memory block has an empty page in the first storage area and has no empty pages in the second storage, the first data is written into the first storage area of the memory block.

### BRIEF DESCRIPTION OF THE DRAWINGS

These and other features of the inventive concept will become more apparent by describing in detail exemplary embodiments thereof with reference to the accompanying drawings of which:

FIG. 1 is a schematic block diagram illustrating a memory system according to an exemplary embodiment of the present inventive concept;

FIG. 2 is a detailed block diagram illustrating a memory device included in the memory system of FIG. 1;

FIG. 3 illustrates a storage area of a memory cell array illustrated in FIG. 2 according to an exemplary embodiment of the present inventive concept;

FIG. 4 is a circuit diagram illustrating a first memory block included in the memory cell array illustrated in FIG. 3 according to an exemplary embodiment of the present inventive concept;

FIG. 5 is a cross-sectional view, taken along a bit line direction, of the first memory block illustrated in FIG. 4 according to an exemplary embodiment of the present inventive concept;

FIG. 6 is a cross-sectional view, taken along a word line direction, of the first memory block illustrated in FIG. 4 according to an exemplary embodiment of the present inventive concept;

FIG. 7 is a cross-sectional view, along a bit line direction, of the first memory block illustrated in FIG. 4 according to an exemplary embodiment of the present inventive concept;

FIG. 8 is a circuit diagram illustrating a cell string included in the first memory block illustrated in FIG. 4 according to an exemplary embodiment of the present inventive concept;

FIG. 9 is a circuit diagram illustrating a cell string included in the first memory block illustrated in FIG. 4 according to an exemplary embodiment of the present inventive concept;

FIG. 10 is a circuit diagram illustrating the first memory block included in a memory cell array illustrated in FIG. 3 according to another embodiment of the present inventive concept;

FIG. 11 is a cross-sectional view of a memory cell included in the first memory block of FIG. 4 or the first memory block of FIG. 10 according to an embodiment of the present inventive concept;

FIG. 12A is a graph showing shift in threshold voltage distributions of memory cells according to an exemplary embodiment of the present inventive concept;

FIG. 12B is a graph showing shift in threshold voltage distributions of memory cells according to an exemplary embodiment of the present inventive concept;

FIG. 13 is a detailed block diagram of a memory controller included in the memory system of FIG. 1 according to an exemplary embodiment of the present inventive concept;

FIG. 14 is a conceptual diagram illustrating a relationship between memory blocks in a memory system according to an exemplary embodiment of the present inventive concept;

FIG. 15 is a conceptual diagram of memory blocks to illustrate a method of managing hot data in a memory system according to an exemplary embodiment of the present inventive concept;

FIG. 16 is a conceptual diagram of memory blocks to illustrate a method of managing hot data in a memory system according to an exemplary embodiment of the present inventive concept;

FIG. 17 illustrates a garbage collection operation without performing cold zone leveling in a memory system according to an exemplary embodiment of the present inventive concept;

FIG. 18 illustrates a garbage collection operation with cold zone leveling in a memory system according to an exemplary embodiment of the present inventive concept;

FIG. 19 is a flowchart of a method of managing a storage area in a memory system according to an exemplary embodiment of the present inventive concept;

FIG. 20 is a flowchart of a method of managing a storage area in a memory system according to an exemplary embodiment of the present inventive concept;

FIG. 21 illustrates an address conversion operation performed on cold data illustrated in FIG. 19 or FIG. 20 according to an exemplary embodiment of the present inventive concept;

FIG. 22 illustrates an address conversion operation performed on cold data illustrated in FIG. 19 or FIG. 20 according to an exemplary embodiment of the present inventive concept;

FIG. 23 illustrates an address conversion operation performed on hot data illustrated in FIG. 19 or FIG. 20 according to an exemplary embodiment of the present inventive concept;

FIG. 24 is a flowchart of a write operation in a memory system according to an exemplary embodiment of the present inventive concept;

FIG. 25 is a block diagram of a memory system including a memory card system according to an exemplary embodiment of the present inventive concept;

FIG. 26 is a block diagram illustrating a computing system including a memory system according to an exemplary embodiment of the present inventive concept; and

FIG. 27 is a block diagram illustrating a solid state drive (SSD) system according to an exemplary embodiment of the present inventive concept.

### DETAILED DESCRIPTION OF EXEMPLARY EMBODIMENTS

Exemplary embodiments of the inventive concept will be described below in detail with reference to the accompanying drawings. However, the inventive concept may be embodied in different forms and should not be construed as limited to the embodiments set forth herein. In the drawings, the thickness of layers and regions may be exaggerated for clarity. It will also be understood that when an element is referred to as being “on” another element or substrate, it may be directly on the other element or substrate, or intervening layers may also be present. It will also be understood that when an element is referred to as being. “coupled to” or “connected to” another element, it may be directly coupled to or connected to the other element, or intervening elements may also be present Like reference numerals may refer to the like elements throughout the specification and drawings.

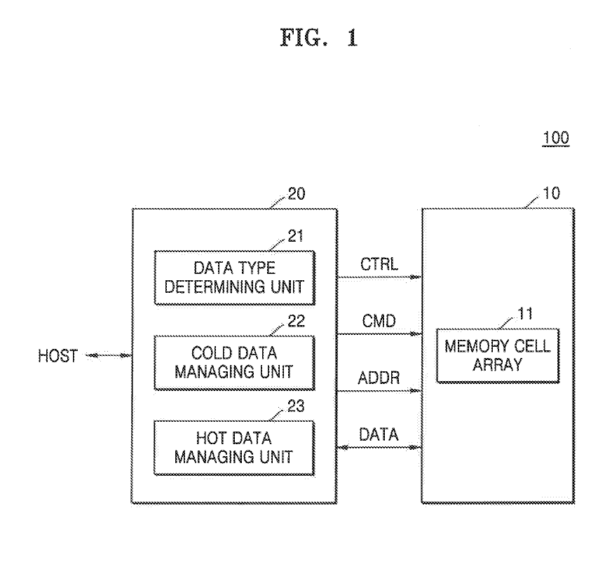

FIG. 1 is a schematic block diagram illustrating a memory system 100 according to an exemplary embodiment of the present inventive concept.

As illustrated in FIG. 1, the memory system 100 includes a memory device 10 and a memory controller 20. The memory device 10 includes a memory cell array 11, and the memory controller 20 includes a data type determining unit 21, a cold data managing unit 22, and a hot data managing unit 23.

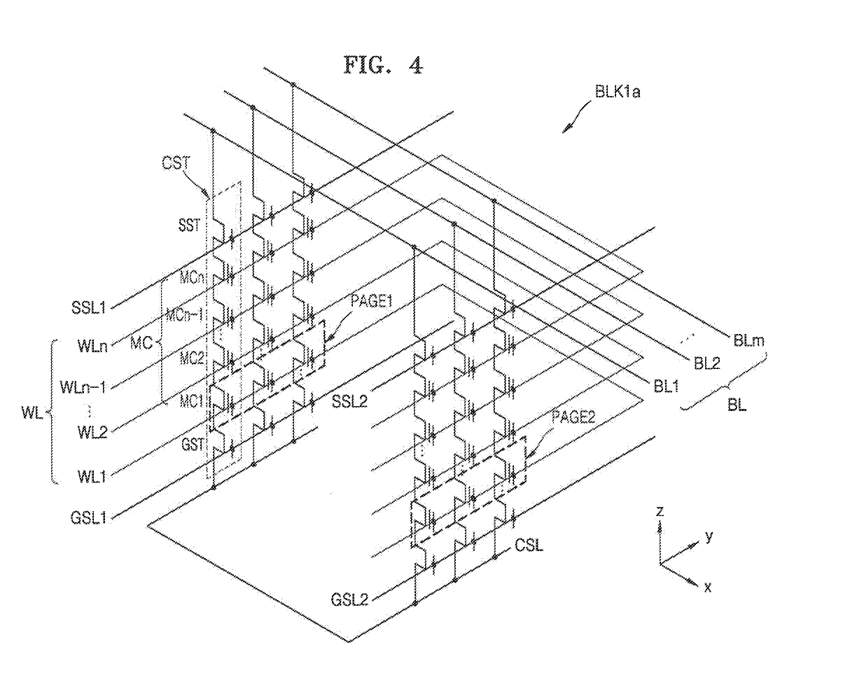

The memory cell array 11 may include a plurality of memory cells that are arranged in areas where a plurality of word lines WL (FIG. 4) and a plurality of bit lines BL (FIG. 4) cross each other. The plurality of memory cells may be flash memory cells, and the memory cell array 11 may be a NAND flash memory cell array or a NOR flash memory cell array.

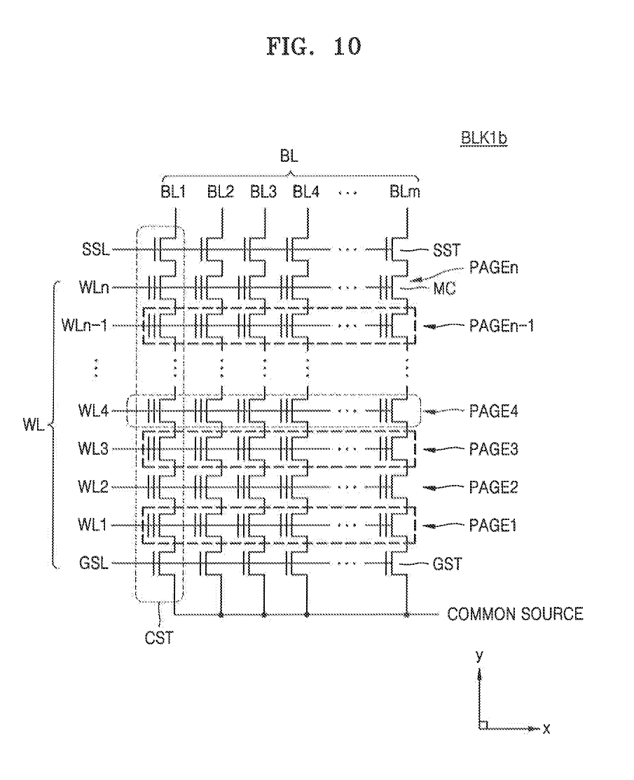

Hereinafter, exemplary embodiments of the inventive concept will be described based on NAND flash memory cells as the plurality of memory cells. For example, the plurality of memory cells may be vertical NAND (VNAND) flash memory cells having a three-dimensional vertical structure (see FIGS. 4 through 9) or two-dimensional planar NAND flash memory cells (see FIG. 10). However, the inventive concept is not limited thereto, and the plurality of memory cells may be resistive memory cells such as resistive RAMs (RRAMs), phase change RAMs (FRAMs), ferroelectric RAMs (FRAMs) or magnetic RAMs (MRAMs).

The memory cell array 11 includes a plurality of memory blocks. Each memory block may include a first storage area and a second storage area based on charge loss according to time. The first storage area may include memory cells having greater charge loss according to time than the second storage area. The first storage area may be referred to as a hot zone, and the second storage area may be referred to as a cold zone.

The memory blocks of the memory device 10 may be classified as a data block, an active block, and a free block, The data block. may refer to a memory block in which data is written to every page, referring to a block of which writable pages are all used. The active block may refer to a memory block in which data is written to some pages, referring to a block having empty pages to which data may be written. The free block may refer to a memory block from which data is erased, referring to a block of which all of pages are empty.

For example, in a three-dimensional VNAND flash memory device, memory cells that are connected to a first critical word line or to word lines that are above the first critical word line may be determined as a first storage area, and memory cells connected to word lines that are below the first critical word line may be determined as a second storage area. For example, the first critical word line may be determined based on measurement of charge loss according to time after a programming operation with respect to memory cells of each word line in a test process. For example, after a programming operation is performed on each block, and an initially set time has elapsed, a distribution of a threshold voltage of each word line is sequentially tested from the lowermost word line to the uppermost word line, and a word line of which a threshold voltage distribution starts to deteriorate to a critical level or higher may be determined as a first critical word line.

For a planar NAND flash memory device, memory cells that are connected to word lines that are below a second critical word line or connected to word lines that are above a third critical word line of the planar NAND flash memory device may be determined as the first storage area, and memory cells that are not included in the first storage area may be determined as the second storage area. The third critical word line is above the second critical word line. For example, the second critical word line and the third critical word line may be determined based on measurement of charge loss according to elapsed time after a programming operation with respect to memory cells of each word line in a test process. For example, after a programming operation of each block is performed, and after an initially set time has been elapsed, a distribution of a threshold voltage of each word line is sequentially tested from the lowermost word line to the uppermost word line. The second critical word line is a lower critical word line, and threshold voltage distributions of memory cells connected to a word line next to the second critical word line start to start to have a normal level. For example, memory cells connected to the second critical word line or memory cells connected to word lines below the second critical word line may have deteriorated threshold voltage distributions which do not represent their corresponding data status. The third critical word line is an upper critical word line, and threshold voltage distributions of memory cells connected to the third critical word line start to deteriorate to a critical level or higher. For example, memory cells connected to the third critical word line or memory cells connected to word lines above the third critical word line may have deteriorated threshold voltage distributions which do not represent their corresponding data status.

The memory controller 20 may perform a control operation on the memory device 10. For example, the memory controller 20 generates an address ADDR, a command CMD, and a control signal CTRL to control the memory device 10 based on a command and an address received from a host HOST. Also, the memory controller 20 may control programming (or writing), reading, and erasing operations with respect to the memory device 10 by providing the memory device 10 with an address ADDR, a command CMD, and a control signal CTRL. Also, data DATA for a programming operation and read data DATA may be transmitted or received between the memory controller 20 and the memory device 10.

The data type determining unit 21 determines a data to be written to the memory device 10 based on an update frequency of the data as hot data or cold data. For example, if the update frequency of data is a critical value or higher, the data may be determined as hot data. If the update frequency is less than the critical value, the data may be determined as cold data. Alternatively, if data is updated before a predetermined time, the data may be determined as hot data, and if data is updated after the predetermined time, the data may be determined as cold data. Also, an update frequency of a data to be written may be predicted according to file attribute, and the data may be determined as a hot data or a cold data based on the predicted update frequency. For example, document files with a file extension such hwp, doc or ppt may have a high probability of having frequent updates. Thus, data predicted to have a high update frequency such as document files may be determined as a hot data, and the other data may be determined as cold data. The inventive concept is not limited thereto, and data to be written may be classified as hot data or cold data by using various methods.

The data type determining unit 21 may further categorize the cold data into multiple levels, based on an update frequency. For example, cold data may be categorized further into a plurality of sub-cold levels based on an update frequency of the cold data.

Alternatively, the determining of data to be written, as hot data or cold data, may be performed in a host HOST instead of the memory controller 20. In this case, information about the determination result may be transmitted to the memory controller 20.

The cold data managing unit 22 controls the memory device 10 to write data determined as cold data to a second storage area which is designated as a cold zone of the memory device 10.

For example, if a write request about cold data is issued, and if there is a target active block of which a second storage area includes empty pages, the cold data managing unit 22 may control the memory device 10 to write the cold data requested to be written to an empty page of the second storage area in the target active block. For example, the cold data managing unit 22 may issue to the memory device 10 an address ADDR, a command CMD, and a control CTRL necessary to write the cold data which is requested to be written to an empty page of the second storage area in the target active block. Also, the cold data requested to be written may be transmitted to the memory device 10. If a target active block having an empty page in the second storage area is not found in the memory device 10, the cold data managing unit 22 controls the memory device 10 to write the cold data requested to be written to a second storage area in a free block. For example, the cold data managing unit 22 issues to the memory device 10 an address ADDR, a command CMD, and a control CTRL necessary to write the cold data which is requested to be written to a free block. Also, the cold data requested to be written may also be transmitted to the memory device 10.

In an exemplary embodiment, if a write request with respect to cold data is issued, the cold data managing unit 22 may designate a sub-cold level with respect to a second storage area of an active block of the memory device 10, and controls the memory device 10 such that the designated active block stores cold data having the same sub-cold level as the designated sub-cold level to the active block. For example, the cold data managing unit 22 may issue to the memory device 10 an address ADDR, a command CMD, and a control CTRL necessary to write cold data which is requested to be written to an empty page of the second storage area in the target active block if there is a target active block with an empty page in the second storage area corresponding to a sub-cold level of cold data requested to be written from among active blocks. Also, the cold data requested to be written may also be transmitted to the memory device 10. If a target active block having an empty page of the second storage area is not found in the memory device 10, the cold data managing unit 22 may control the memory device 10 to write the cold data requested to be written to a second storage area in a free block. For example, the cold data managing unit 22 may issue to the memory device 10 an address ADDR, a command CMD, and a control CTRL necessary to write cold data which is requested to be written to an empty page of the second storage area in the free block. Also, the cold data requested to be written may also be transmitted to the memory device 10. In this case, the cold data managing unit 22 may designate the sub-cold level of the cold data that is initially written to the free block, as a sub-cold level with respect to a second storage area of the free block.

The hot data managing unit 23 may control the memory device 10 to write hot data to the first storage area designated as a hot zone of the memory device 10.

For example, the hot data managing unit 23 may control the memory device 10 to write hot data to the first storage area in a target active block with no empty page in the second storage area, if there is a write request with respect to hot data. For example, the hot data managing unit 23 may issue to the memory device 10 an address ADDR, a command CMD, and a control CTRL necessary to write hot data which is requested to be written to the first storage area in the target active block. Also, the hot data requested to be written may also be transmitted to the memory device 10. If an active block of which a second storage has no empty page is not found in the memory device 10, the hot data managing unit 23 may control the memory device 10 to write the hot data requested to be written to an empty page of a second storage area in one of active blocks. For example, if a target active block having no empty pages in the second storage area (or the cold zone) is not found in the memory device 10, the hot data managing unit 23 may issue to the memory device 10 an address ADDR, a command CMD, and a control CTRL necessary to write hot data which is requested to be written to an empty page of a second storage area in one of active blocks. Also, the hot data requested to be written may also be transmitted to the memory device 10.

If a write request with respect to hot data is issued, and if a target active block of which empty pages of a second storage area are all used is not found from among active blocks, the hot data managing unit 23 may control the memory device 10 to write the hot data requested to be written to an empty page of the second storage area in an active block including a second storage area which stores a cold data with the highest update frequency, from among active blocks. For example, if the target active block is not found, the hat data managing unit 23 may transmit to the memory device 10 an address ADDR, a command CMD, and a control CTRL needed to write hot data which is requested to be written to an empty page of a second storage area in an active block that is designated with a sub-cold level with the highest update frequency, from among active blocks. Also, the hot data requested to be written is transmitted to the memory device 10.

The data type determining unit 21, the cold data managing unit 22, and the hot data managing unit 23 included in the memory controller 20 described above may be implemented in hardware design or firmware design.

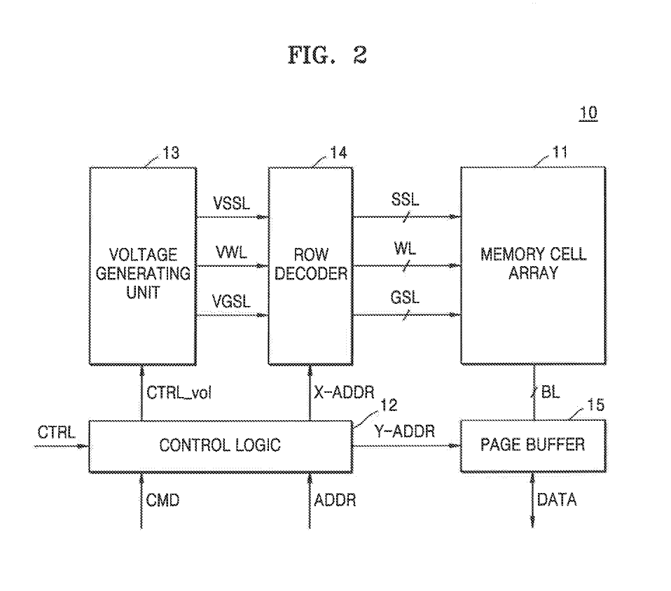

FIG. 2 is a detailed block diagram illustrating the memory device 10 included in a memory system of FIG. 1 according to an exemplary embodiment of the present inventive concept.

Referring to FIG. 2, the memory device 10 includes a memory cell array 11, a control logic 12, a voltage generating unit 13, a row decoder 14, and a page buffer 15. Hereinafter, elements included in the memory device 10 will be described.

The memory cell array 11 is connected to one or more string select lines SSL, a plurality of word lines WL, one or more ground select lines GSL, and also to a plurality of bit lines BL. The memory cell array 11 may include a plurality of memory cells MC (FIGS. 4, 9, and 11) arranged in areas where the plurality of word lines WL and the plurality of bit lines BL cross each other.

When an erase voltage is applied to the memory cell array 11, the plurality of memory cells MC are in an erase state, and when a programming voltage is applied to the memory cell array 11, the plurality of memory cells MC are in a programming state. Here, each memory cell MC may have an erase state and one of first through n-th programming states P1 through Pn which are classified according to a threshold voltage.

Here, n may be a natural number of 2 or greater. For example, if a memory cell MC is a 2-bit level cell, n may be 3. Alternatively, if the memory cell MC is a 3-bit level cell, n may be 7. Alternatively, if the memory cell MC is a 4-bit level cell, n may be 15. As described above, the plurality of memory cells MC may include multi-level cells. However, the present inventive concept is not limited thereto, and the plurality of memory cells MC may include single-level cells.

The control logic 12 issues various control signals to write data to the memory cell array 11 or read data from the memory cell array 11 based on a command CMD, an address ADDR, and a control signal CTRL received from a memory controller 210. Thus, the control logic 12 may control various operations in the memory device 10.

Various control signals output from the control logic 12 may be provided to the voltage generating unit 13, the row decoder 14, and the page buffer 15. For example, the control logic 12 provides the voltage generating unit 13 with a voltage control signal CTRL_vol, and provides the row decoder 14 with a row address X_ADDR and the page buffer 15 with a column address Y_ADDR.

The voltage generating unit 13 generates various types of voltages to perform programming, reading and erasing on the memory cell array 11 based on the voltage control signal CTRL_vol. For example, the voltage generating unit 13 generates a first driving voltage VWL to drive a plurality of word lines WL, a second driving voltage VSSL to drive a plurality of string select lines SSL, and a third driving voltage VGSL to drive a plurality of ground select lines GSL.

The first driving voltage VWL may be a programming voltage (or write voltage), arcading voltage, an erase voltage, a pass voltage or a programming verify voltage. Also, the second driving voltage VSSL may be a string select voltage having an on voltage or an off voltage for a string selection transistor. Furthermore, the third driving voltage VGSL may be a ground select voltage having an on voltage or an off voltage for a ground selection transistor.

According to an exemplary embodiment, when a programming loop starts, that is, when a frequency of a programming loop is 1, the voltage generating unit 13 may generate a programming start voltage as a programming voltage based on the voltage control signal CTRL_vol. Also, the voltage generating unit 13 may generate, as a programming voltage, a voltage that increases stepwise by a step voltage from a programming start voltage as a program loop frequency increases.

The row decoder 14 is connected to the memory cell array 11 via a plurality of word lines WL, and may activate some of the plurality of word lines WL in response to a row address X_ADDR received from the control logic 12. For example, in a reading operation, the row decoder 14 may apply a reading voltage to a selected word line, and apply a pass voltage to a non-selected word line.

Meanwhile, in a programming operation, the row decoder 14 may apply a programming voltage to a selected word line and apply a pass voltage to anon-selected word line. In at least one of program loops, the row decoder 14 may apply a program voltage to a selected word line and a word line that is additionally selected.

The page buffer 15 is connected to the memory cell array 11 through a plurality of bit lines BL. For example, in a reading operation, the page buffer 15 may operate as a sense amplifier to output data DATA stored in the memory cell array 11. In a programming operation, the page buffer 15 may operate as a write driver to input data DATA to be stored in the memory cell array 11.

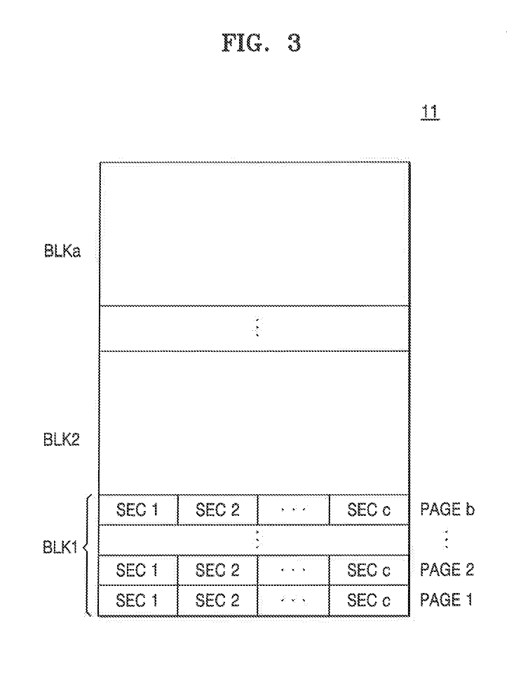

FIG. 3 illustrates a storage area of the memory cell array 11 illustrated in FIG. 2 according to an exemplary embodiment of the present inventive concept.

Referring to FIG. 3, the memory cell array 11 may be a flash memory cell array. The memory cell array 11 includes memory blocks BLK1 through BLKa (where a is an integer that is 2 or greater), and each of the memory blocks BLK1 through BLKa includes pages PAGE1 through PAGEb (where b is an integer that is 2 or greater), and each of the pages PAGE1 through PAGEb includes sectors SEC1 through SECc (where c is an integer that is 2 or greater). In FIG. 3, for convenience of illustration, pages PAGE0 through PAGEb and sectors SEC1 through SECc are illustrated only with respect to a memory block BLK1, but other memory blocks BLK2 through BLKa may also have the same structure as that of the block BLK1.

FIG. 4 is a circuit diagram illustrating a first memory block BLK1a included in the memory cell array 11 of FIG. 3 according to an exemplary embodiment of the present inventive concept.

Referring to FIG. 4, the first memory block BLK1a is a vertical NAND flash memory. The blocks BLK1 through BLKa of FIG. 3 may be implemented as shown in FIG. 4. In FIG. 4, a first direction may be referred to as an x-direction, a second direction may be referred to as a y-direction, and a third direction may be referred to as a z-direction. However, the present inventive concept is not limited thereto, and the first through third directions may be changed.

The first memory block BLK1a includes a plurality of cell strings CST, a plurality of word lines WL, a plurality of bit lines BL, a plurality of ground select lines GSL1 and GSL2, a plurality of string selects lines SSL1 and SSL2, and a common source line CSL. The number of the cell strings CST, the number of word lines WL, the number of bit lines BL, the number of the ground select lines GSL1 and GSL2, and the number of string select lines SSL1 and SSL2 may be modified in various manners according to an exemplary embodiment.

A cell string CST includes a string select transistor SST that is serially connected between a corresponding bit line BL and a corresponding common source line CSL, a plurality of memory cells MC, and a ground select transistor GST. However, the inventive concept is not limited thereto. For example, a cell string CST may further include at least one dummy cell. A cell string CST may include at least two string select transistors or at least two ground select transistors.

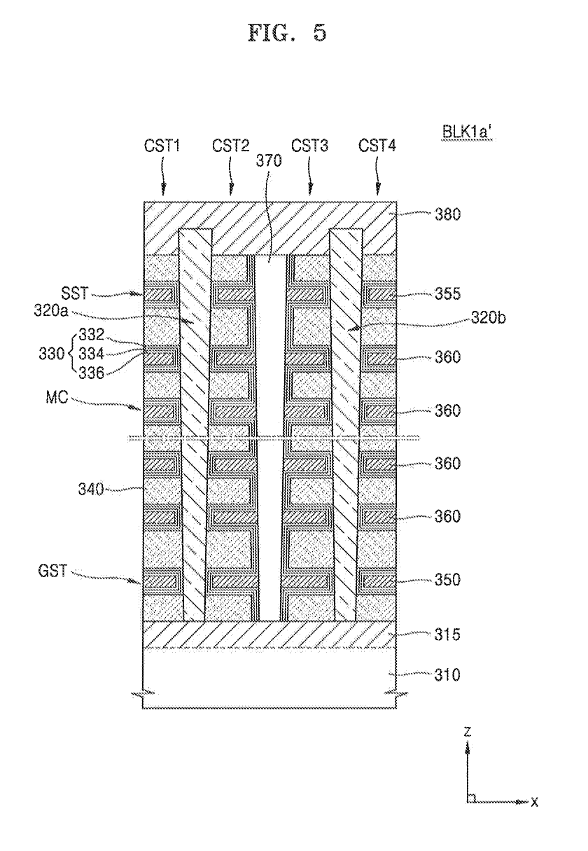

A cell string CST extends in the third direction (z-direction). For example, the cell string CST extends in a vertical direction (z-direction) on a substrate 310 (FIG. 5). Accordingly, the memory block BLK1a including the cell string CST may be referred to as a vertical NAND flash memory. As described above, an integration degree of the memory cell array 11 may be increased by extending the cell string CST in a vertical direction (z-direction) from a substrate.

The plurality of word lines WL may extend in the first direction (x-direction) and the second direction (y-direction) and may be respectively connected to corresponding memory cells MC. Accordingly, a plurality of memory cells MC arranged adjacent to one another along the first direction (x-direction) and the second direction (y-direction) on the same layer may be connected to the same word line WL. For example, each word line WL may be connected to a gate of a memory cell MC to control the memory cell MC. The plurality of memory cells MC may store data, and may be programmed, read, or erased according to control via the connected word line WL.

The plurality of bit lines BL may extend in the first direction (x-direction) and be connected to the string select transistor SST. Accordingly, a plurality of string select transistors SST arranged adjacent to one another along the first direction (x) may be connected to the same bit line BL. For example, each bit line BL may be connected to a drain of the string select transistor SST.

The plurality of string select lines SSL1 and SSL2 may extend in the second direction (y-direction) and be connected to the string select transistor SST. Accordingly, the plurality of string select transistor SST arranged adjacent to one another in the second direction (y-direction) may be connected to the same string select line SSL1 or SSL2. For example, each string select line SSL1 or SSL2 may be connected to a gate of a string select transistor SST to control the string select transistor SST.

The plurality of ground select lines GSL1 and GSL2 may extend in the second direction (y-direction) and be connected to the ground select transistor GST. Accordingly, the plurality of ground select transistors GST arranged adjacent to one another in the second direction (y-direction) may be connected to the same ground select line GSL1 or GSL2. For example, each ground select line GSL1 or GSL2 may be connected to a gate of a ground select transistor GST to control the ground select transistor GST.

Also, the ground select transistors GST respectively included in the cell strings CST is commonly connected to a common source line CSL. For example, the common source line CSL is connected to a source of the ground select transistor GST.

Here, a plurality of memory cells MC that are commonly connected to the same word line WL and the same string select line SSL1 or SSL2 and arranged adjacent to one another along the second direction (y-direction) may be referred to as a page PAGE. For example, a plurality of memory cells MC that are commonly connected to a first word line WL1 and a first string select line SSL1 and arranged adjacent to one another along the second direction (y-direction) may be referred to as a first page PAGE1. Also, a plurality of memory cells MC that are commonly connected to the first word line WL and a second string select line SSL2 and arranged adjacent to one another along the second direction (y-direction) may be referred to as a second page PAGE2.

To perform a programming operation on a memory cell MC, 0V may be applied to a bit line BL, an on voltage may be applied to a string select line SSL, and an off voltage may be applied to the ground select line GSL. The on voltage may be greater than or equal to a threshold voltage of the string select transistor SST to turn on the string select transistor SST, and the off voltage may be smaller than the threshold voltage to turn off the ground select transistors GST. Also, from among the memory cells MC, a programming voltage may be applied to a memory cell selected by one of the plurality of word lines WL1 to WLn, and a pass voltage may be applied to the other memory cells which are not selected by one of the plurality of word lines WL1 to WLn. When a programming voltage is applied, charges may be injected into the memory cells MC by F-N tunneling. The pass voltage may be greater than a threshold voltage of the memory cells MC.

In an erasing operation of the memory cells MC, an erase voltage may be applied to a body of the memory cells MC, and 0V may be applied to the word lines WL. Accordingly, data of the memory cells MC may be erased at a time. In an exemplary embodiment, the erasing operation may be performed simultaneously on memory cells in a block.

In an embodiment of the present inventive concept, a three dimensional (3D) memory array is provided. The 3D memory array is monolithically formed in one or more physical levels of arrays of memory cells having an active area disposed above a silicon substrate and circuitry associated with the operation of those memory cells, whether such associated circuitry is above or within such substrate. The term “monolithic” means that layers of each level of the array are directly deposited on the layers of each underlying level of the array.

In an embodiment of the present inventive concept, the 3D memory array includes vertical NAND strings that are vertically oriented such that at least one memory cell is located over another memory cell. The at least one memory cell may comprise a charge trap layer.

The following patent documents, which are hereby incorporated by reference, describe suitable configurations for three-dimensional memory arrays, in which the three-dimensional memory array is configured as a plurality of levels, with word lines and/or bit lines shared between levels: U.S. Pat. Nos. 7,679,133; 8,553,466; 8,654,587; 8,559,235; and US Pat. Pub. No. 2011/0233648.

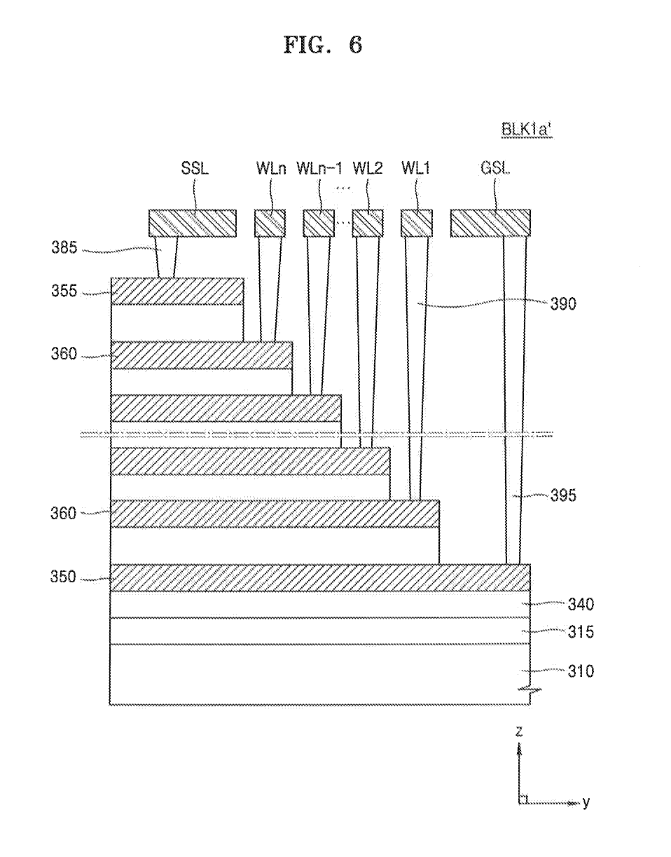

FIG. 5 is a cross-sectional view taken along a bit line direction of the first memory block BLK1a′ of FIG. 4 according to an exemplary embodiment of the present inventive concept. FIG. 6 is a cross-sectional view taken along a word line direction of the first memory block BLK1a′ of FIG. 4 according to an exemplary embodiment of the present inventive concept.

Referring to FIGS. 5 and 6, the first memory block BLK1a′ has a substrate 310 that has a main surface extending in the first direction (x). The substrate 310 may include a semiconductor material such as a Group IV semiconductor, a Group III-V compound semiconductor, or a Group II-VI oxide semiconductor. For example, a Group IV semiconductor may include silicon, germanium or silicon-germanium. The substrate 310 may be provided as a bulk wafer or an epitaxial layer.

Semiconductor pillars 320a and 320b are arranged on the substrate 310 to vertically extend from the substrate 310. The semiconductor pillars 320a and 320b may include a semiconductor material such as polysilicon or single crystalline silicon. The semiconductor material may be undoped or may include a p-type or an n-type impurity.

The substrate 310 includes an impurity area 315 under the semiconductor pillars 320a and 320b. The impurity area 315 may be a source area and may form a PN junction with other areas of the substrate 310. A common source line CSL of FIG. 4 may be connected to the impurity area 315. Alternatively, the impurity area 315 may form a lower portion of the semiconductor pillars 320a and 320b.

Each of the memory cells MC includes a storage medium 330 on a sidewall of the semiconductor pillars 320a and 320b and a control gate electrode 360 on the storage medium 330. Each storage medium 330 includes a tunneling insulation layer 332 disposed on a sidewall of the semiconductor pillars 320a and 320b, a charge storage layer 334 disposed on the tunneling insulation layer 332, and a blocking insulation layer 336 disposed on the charge storage layer 334.

The charge storage layer 332 may store charges as data storage. For example, the charge storage layer 332 may be a trap type charge storage layer, and may include, for example, a silicon nitride layer, quantum dots or nanocrystals. The quantum dots or nanocrystals may be formed of a conductor such as fine particles of a metal or a semiconductor. The tunneling insulating layer 335 and the blocking insulating layer 336 may include an oxide layer, a nitride layer, or a high-k dielectric layer. The high-k dielectric layer may refer to as a dielectric layer having a higher dielectric constant than that of an oxide layer and a nitride layer.

The string select transistor SST includes a string select gate electrode 355 disposed on a sidewall of the semiconductor pillars 320a and 320b. The string select transistor SST may be connected to the bit line 380. The bit line 380 may be formed of a line-shaped pattern extending in the first direction (x-direction). The ground select transistor GST includes a ground select gate electrode 350 disposed on a sidewall of the semiconductor pillars 320a and 320b.

The storage media 330 between the string select transistor SST and the semiconductor pillars 320a and 320b and between the ground select transistor GST and the semiconductor pillars 320a and 320b may function as a gate insulation layer, and thus, may also be replaced by a single insulation layer. Interlayer insulation layers 340 are interposed between the ground select gate electrodes 350, the control gate electrodes 360, and the string select gate electrodes 355. The storage media 330 extends along a surface of the interlayer insulation layers 340.

The first and second cell strings CST1 and CST2 are arranged adjacent to each other, and the semiconductor pillar 320a is disposed between the first and second cell strings CST1 and CST2. The third and fourth cell strings CST3 and CST4 are arranged adjacent to each other, and the semiconductor pillar 320b is disposed between the third and fourth cell strings CST3 and CST4. An insulation layer 370 is disposed between the second cell string CST2 and the third cell string CST3.

The string select gate electrode 355 is connected to the string select line SSL via a contact plug 385. The control gate electrodes 360 is connected to corresponding word lines WL1 through WILn via contact plugs 390. The ground select gate electrodes 350 is connected to the ground select line GSL via contact plugs 395.

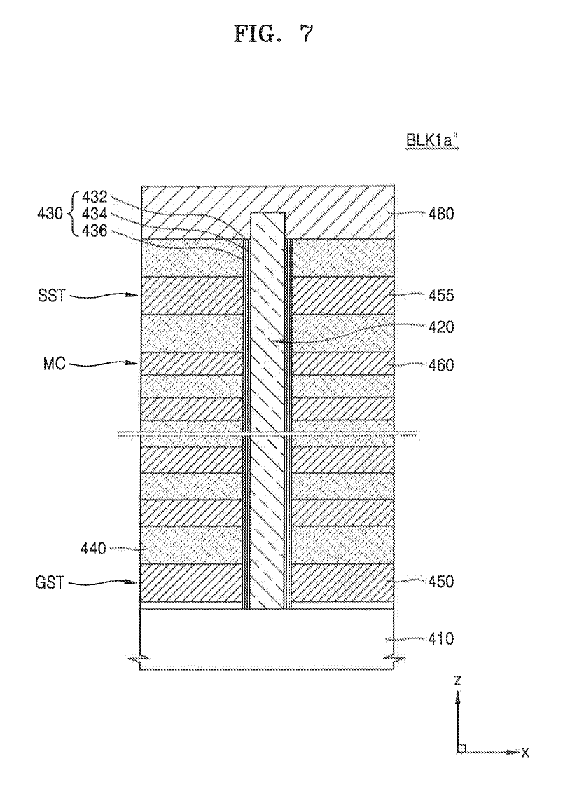

FIG. 7 is a cross-sectional view taken along a bit line direction of the first memory block BLK1a″ of FIG. 4 according to an exemplary embodiment of the present inventive concept.

Referring to FIG. 7, the first memory block BLK1a″ includes a substrate 410 having a main surface extending in the first direction (x-direction). The substrate 410 may include a semiconductor material such as a Group IV semiconductor, a Group compound semiconductor, or a Group II-VI oxide semiconductor, For example, a Group IV semiconductor may include silicon, germanium or silicon-germanium. The substrate 410 may be provided as a bulk wafer or an epitaxial layer.

A semiconductor pillar 420 extends vertically from the substrate 410. The semiconductor pillar 420 may include a semiconductor material such as polysilicon or single crystalline silicon. The semiconductor material may be undoped or may include a p-type or an n-type impurity.

A storage medium 430 is formed to extend in a length direction of the semiconductor pillar 420. Each storage medium 430 includes a tunneling insulation layer 432 disposed on a sidewall of the semiconductor pillar 420, a charge storage layer 434 disposed on the tunneling insulation layer 432, and a blocking insulation layer 436 disposed on the charge storage layer 434.

The string select transistor SST includes a string select gate electrode 455 disposed on a sidewall of the semiconductor pillar 420. The string select transistor SST is connected to a bit line 480. The bit line 480 may be formed of a line-shaped pattern extending in the first direction (x-direction). The ground select transistor GST includes a ground select gate electrode 450 disposed on a sidewall of the semiconductor pillar 420.

The storage media 430 disposed between the string select transistor SST and the semiconductor pillar 420 and between the ground select transistor GST and the semiconductor pillar 420 may function as a gate insulation layer, and thus, may also be replaced by a single insulation layer. Interlayer insulation layers 440 are interposed between the ground select gate electrodes 450, the control gate electrodes 460, and the string select gate electrodes 455. The storage media 430 extends along a surface of the interlayer insulation layers 440.

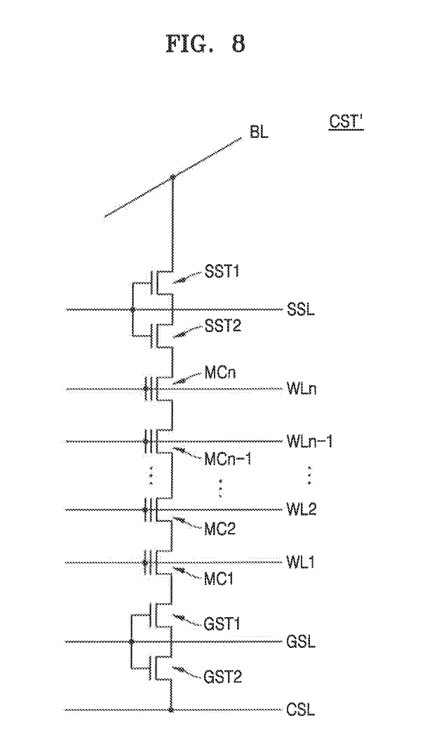

FIG. 8 is a circuit diagram illustrating a cell string CST′ of the first memory block of FIG. 4 according to an exemplary embodiment of the present inventive concept.

Referring to FIG. 8, the cell string CST includes a pair of string select transistors SST1 and SST2, a plurality of memory cells MC, and a pair of ground select transistors GST1 and GST2. A bit line BL is connected to a first end of the cell string CST, and a common source line CSL is connected to a second end of the cell string CST.

Some of elements included in the cell string CST′ according to the present embodiment may be substantially the same as elements included in the cell string CST of FIG. 4 and may be referred to using the same reference numerals, and description of the same elements as those of the cell string CST of FIG. 4 will not be repeated. Hereinafter, description will focus on a difference between the cell string CST of FIG. 4 and the cell string CST according to the present embodiment.

The plurality of memory cells MC is vertically and serially arranged. The memory cells MC may store data. The plurality of word lines WL is connected to the memory cells MC to control the memory cells MC. The number of memory cells MC may change according to a capacity of a non-volatile memory device.

The string select transistors SST1 and SST2 are arranged adjacent to each other at a first side of the memory cells MC. For example, the string select transistors SST1 and SST2 are arranged between a bit line BL and an n-th memory cell MCn and are serially connected to the n-th memory cell MCn. The string select transistors SST1 and SST2 may control signal transmission between the bit line BL and the memory cells MC. The string select line SSL is commonly coupled to the string select transistors SST1 and SST2. Thus, the string select transistors SST1 and SST2 may act like a single transistor in an operation.

The ground select transistors GST1 and GST2 are arranged adjacent to each other opposite to the string select transistors SST1 and SST2 at a second side of the memory cells MC. For example, the ground select transistors GST1 and GST2 are disposed between the common source line CSL and the first memory cell MC1 and are serially connected to the first memory cell MC1. The ground select transistors GST1 and GST2 may control signal transmission between the common source line CSL and the memory cells MC. The ground select line GSL is commonly coupled to the ground select transistors GST1 and GST2. Thus, the ground select transistors GST1 and GST2 may act like a single transistor in an operation.

According to an exemplary embodiment, by providing at least two string select transistors SST1 and SST2, a length of each string select gate electrode 355 (FIG. 5) may be reduced compared to when one string select transistor is included. Thus, space between the interlayer insulating layers 340 (FIG. 5) may be filled without any void. Furthermore, by providing at least two ground select transistors GST1 and GST2, a length of each ground select gate electrode 350 (FIG. 5) may be reduced compared to when one ground select transistor is included. Thus, space between the interlayer insulating layers 340 (FIG. 5) may be filled without any void.

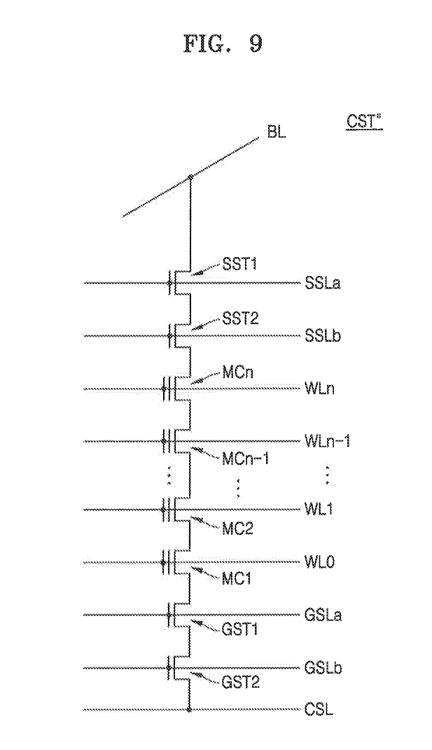

FIG. 9 is a circuit diagram illustrating a cell string CST in the first memory block of FIG. 4 according to an exemplary embodiment of the present inventive concept.

Referring to FIG. 9, the cell string CST″ includes a pair of string select transistors SST1 and SST2, a plurality of memory cells MC, and a pair of ground select transistors GST1 and GST2. A bit line BL is connected to a first end of the cell string CST″, and a common source line CSL is connected to a second end of the cell string CST″. Some of elements included in the cell string CST″ according to the present embodiment may be substantially the same as elements included in the cell string of FIG. 8. The same elements may be referred to using the same reference numerals, and description of the same elements as those of the cell string CST′ of FIG. 8 will not be repeated. Hereinafter, description will focus on a difference between the cell string CST′ of FIG. 8 and the cell string CST″ according to the present embodiment.

The string select transistors SST1 and SST2 are arranged adjacent to each other at a first side of the memory cells MC. For example, the string select transistors SST1 and SST2 are arranged between a bit line BL and an n-th memory cell MCn and are serially connected to the n-th memory cell MCn. The string select transistors SST1 and SST2 may control signal transmission between the bit line 131, and the memory cells MC. A first string select line SSLa is connected to a first string select transistor SST1, and a second string select line SSLb is connected to a second string select transistor SST2.

The ground select transistors GST1 and GST2 are arranged adjacent to each other opposite to the string select transistors SST1 and SST2, at a second side of the memory cells MC. For example, the ground select transistors GST1 and GST2 are arranged between a common source line CSL and a first memory cell MC1 and are serially connected to the first memory cell MC1. The ground select transistors GST1 and GST2 may control signal transmission between the common source line CSL and the memory cells MC. A first ground select line GSLa is connected to a first ground select transistor GST1, and a second ground select line CSLb is connected to a second string ground select transistor GST2.

FIG. 10 is a circuit diagram illustrating a first memory block BLK1b included in the memory cell array 11 of FIG. 3 according to an exemplary embodiment of the present inventive concept.

Referring to FIG. 10, the first memory block BLK1b is a two-dimensional planar NAND flash memory. The blocks BLK1 and BLKa illustrated in FIG. 3 may be implemented as shown in FIG. 10. In FIG. 10, a first direction may be referred to as an x-direction, and a second direction may be referred to as a y-direction. However, the inventive concept is not limited thereto, and the first and second directions may be changed.

The first memory block BLK1b includes a plurality of cell strings CST, a plurality of word lines WL, a plurality of bit lines BL, a plurality of ground select lines GSL1 and GSL2, a plurality of string selects lines SSL1 and SSL2, and a common source line CSL. The number of the cell strings CST, the number of word lines WL, the number of bit lines BL, the number of the ground select lines GSL1 and GSL2, and the number of string select lines SSL1 and SSL2 may change according to exemplary embodiments.

The cell string CST includes a string select transistor SST, a plurality of memory cells MC, and a ground select transistor GST that are serially connected between a bit line BL and a common source line CSL. However, the inventive concept is not limited thereto, and the cell string CST may further include at least one dummy cell.

The NAND flash memory device having the structure as illustrated in FIG. 10 may perform erasing in units of blocks and programming in units of pages PAGE corresponding to the word lines WL1 through WLn.

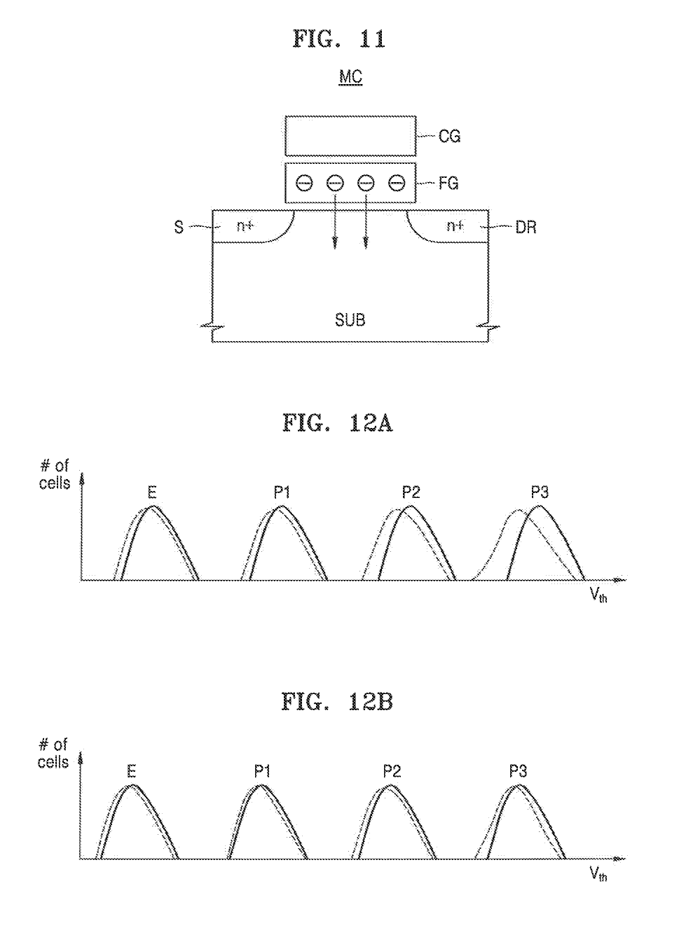

FIG. 11 is a cross-sectional view of a memory cell MC included in the first memory block BLK1a of FIG. 4 or the first memory block BLK1b of FIG. 10 according to an exemplary embodiment of the present inventive concept.

Referring to FIG. 11, a source S and a drain DR are formed on a substrate SUB, and a channel area is formed between the source S and the drain D. A floating gate FG is formed above the channel area, and an insulation layer such as a tunneling insulation layer is disposed between the channel area and the floating gate FG. A control gate CG is formed above the floating gate FG, and an insulation layer such as a blocking insulation layer is disposed between the floating gate FG and the control gate CG. Voltages needed in a programming, erasing, or reading operation with respect to the memory cell MC may be applied to the substrate SUB, the source S, the drain D, and the control gate CG.

In a flash memory device, data stored in the memory cell MC may be read by distinguishing a threshold voltage Vth of the memory cell MC. The threshold voltage Vth of the memory cell MC may be determined based on an amount of electrons stored in the floating gate FG. For example, the more electrons are stored in the floating gate FG, the higher the threshold voltage Vth of the memory cell MC may be. The electrons stored in the floating gate FG of the memory cell MC may leak in an arrow direction due to various reasons. Thus, the threshold voltage Vth of the memory cell MC may be changed. Change loss referring to leakage of electrons stored in the floating gate FG of the memory cell MC affects reading performance of a flash memory device. Charge loss behavior may vary according to storage areas of a flash memory device.

Storage areas of each memory block in a flash memory device may be divided by a test process into a first storage area having poor charge loss behavior and a second storage area having not poor charge loss behavior based on a charge loss according to time.

For example, in a three-dimensional vertical NAND flash memory device, each memory block may have a hot zone and a cold zone as a storage area. A storage area including memory cells that are connected to a first critical word line or word lines that are above the first critical word line may be determined as a first storage area which may be referred to as the hot zone. A storage area including memory cells that are connected to word lines that are below the first critical word line may be determined as a second storage area which may be referred to as the cold zone.

For a planar NAND flash memory device, each memory block may include a first storage area and a second storage area. A storage including memory cells that are connected to a second critical word line, word lines that are below the second critical word line, a third critical word line or word lines that are above the third critical word line may be determined as the first storage area, and memory cells that are not included in the first storage area may be determined as the second storage area. The third critical word line corresponds to a word line that is above the second critical word line.

FIG. 12A is a graph showing shift in threshold voltage distribution of memory cells in the first storage area of the memory device 10 when the memory cell MC of FIG. 11 is a multi-level cell. The solid line represents a threshold voltage distribution of memory cells which are programmed, and the dotted line represents a shifted threshold voltage distribution after an initially set time has elapsed from the programming completion time.

FIG. 12B is a graph showing shift in threshold voltage distribution of memory cells in the second storage area of the memory device 10 when the memory cell MC is a multi-level cell. The sold line represents a threshold voltage distribution of memory cells which are programmed, and dotted line represents a shifted threshold voltage distribution after an initially set time has elapsed from the programming completion time.

Referring to FIGS. 12A and 12B, a horizontal axis denotes a threshold voltage Vth, and a vertical axis denotes the number of memory cells MC. For example, if the memory cell MC is a 2-bit multi-level cell of which is capable of storing two bits, the memory cell MC may have one of an erasing state E, a first programming state P1, a second programming state P2, and a third programming state P3.

As illustrated in FIGS. 12A and 12B, a change in a distribution of memory cells according to a threshold voltage after an initially set time has elapsed from a program completed point is greater in the first storage area than in the second storage area as illustrated in FIGS. 12A and 12B. For example, in the third programming state P3 with a highest threshold voltage, from among the erasing state E, the first programming state P1, the second programming state P2, and the third programming state P3, a large change is generated in a distribution of memory cells according to a threshold voltage at the programming completion time and after an initially set time has elapsed from the programming completion time. Thus, data retention characteristics of the first storage area are poorer than those of the second storage area.

According to an exemplary embodiment, hot data having a high update frequency is stored in the first storage area with poor data retention characteristics.

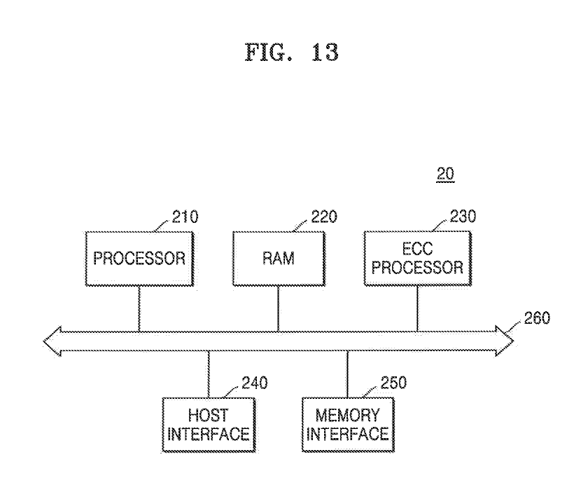

FIG. 13 is a detailed block diagram of the memory controller 20 included in the memory system 100 of FIG. 1 according to an exemplary embodiment of the present inventive concept.

As illustrated in FIG. 13, the memory controller 20 includes a processor 210, a random access memory (RAM) 220, an error correction code (ECC) processor 230, a host interface 240, a memory interface 250, and a bus 260.

Elements of the memory controller 20 may be electrically connected to one another via the bus 260.

The processor 210 controls an overall operation of the memory system 100 by using program codes and data stored in the RAM 220. For example, the processor 210 may be implemented as a microprocessor or a central processing unit (CPU). When the memory system 100 is initialized, program codes and data needed to control operations performed in the memory system 100 may be read from the memory device 10 and loaded to the RAM 220.

For example, when the memory system 100 is initialized, the processor 210 may read from the memory device 100 program codes and data to implement the data type determining unit 21, the cold data managing unit 22, and the hot data managing unit 23 in firmware design and load the program codes and data to the RAM 220.

The processor 210 may provide the memory device 10 with a read command and an address during a reading operation, and provides a write command, an address, and data during a write operation. Also, the processor 210 may perform a process of converting a logical address received from a host, to a physical address by using system data stored in the RAM 220.

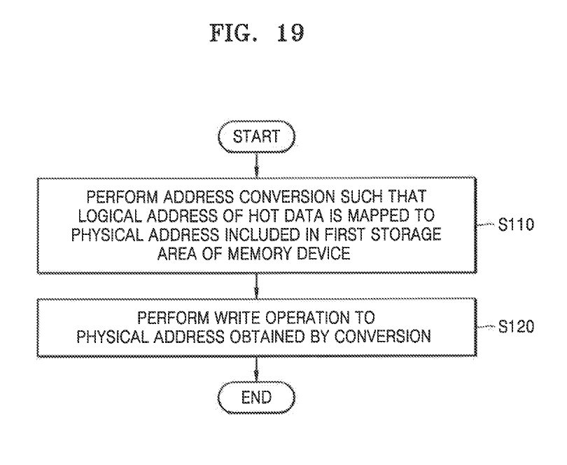

The processor 210 may control the memory device 10 such that, from among hot data that is classified based on an update frequency and cold data having a lower update frequency than hot data, the hot data is written to the first storage area of the memory device 10 by using the program codes and data stored in the RAM 220. The processor 210 may perform a task with respect to the method of managing a storage area in the memory system according to flowcharts of FIGS. 19 through 24 and a write operation by using the program codes and data stored in the RAM 220. The method of managing a storage area in the memory system and the write operation performed by using the processor 210 will be described in detail with reference to FIGS. 19 through 24 below.

Data received through the host interface 240 and data generated by using the processor 210 are temporarily stored or data read from the memory device 10 is temporarily stored in the RAM 220. Also, system data read from the memory device 10 is stored in the RAM 220 as program codes. The RAM 220 may be, for example, a dynamic random access memory (DRAM) or a static random access memory (SRAM). System data may includes information necessary to manage the memory device 10, and includes mapping table information necessary to convert a logical address to a physical address of the memory device 10. For example, the mapping table information may include information about a block belonging to a free block pool, information about a block belonging to an active block pool, and information about a block belonging to a data block pool in a flash memory device. Also, the mapping table information may include information about the first storage area which is a hot zone, information about the second storage area which is a cold zone, and information about sub-cold levels. Also, sub-cold level information about each of blocks may be included in the mapping table information. Also, for example, information corresponding to a sub-cold level corresponding to a logical address or a physical address in a mapping table may be included in the mapping table information.

The ECC processor 230 may generate an ECC with respect to data to be written by using an algorithm such as a Reed-Solomon (RS) code, a Hamming code, or a Cyclic Redundancy Code (CRC) in a write operation. Also, in a reading operation, error detection and correction with respect to received data are performed by using an ECC that is read together with data.

The host interface 240 may operate using a data exchange protocol to communicate with a host that is connected to the memory system 100. The host interface 240 connects the memory system 100 and the host to each other. The host interface 240 may be an Advanced Technology Attachment (ATA) interface, a Serial Advanced Technology Attachment (BATA) interface, a Parallel Advanced Technology Attachment (BATA) interface, a Universal Serial Bus (USB) or a Serial Attached Small Computer System (SAS) interface, a Small Computer System Interface (SCSI), an embedded Multi Media Card (eMMC) interface, or a Universal Flash Storage (UFS) interface. However, the above-described interfaces are exemplary and the host interface 240 is not limited thereto. The host interface 240 may receive a command, an address, and data from the host according to a control of the processor 210 or may transmit data to the host.

The memory interface 250 is electrically connected to the memory device 10. The memory interface 250 may transmit a command, an address, and data to the memory device 10 according to a control of the processor 210 or receive data from the memory device 10. The memory interface 250 may support a NAND flash memory or a NOR flash memory. The memory interface 250 may perform interleave operations on a plurality of channels. For example, the memory interface 250 may implement such interleave operations in software or hardware circuits.

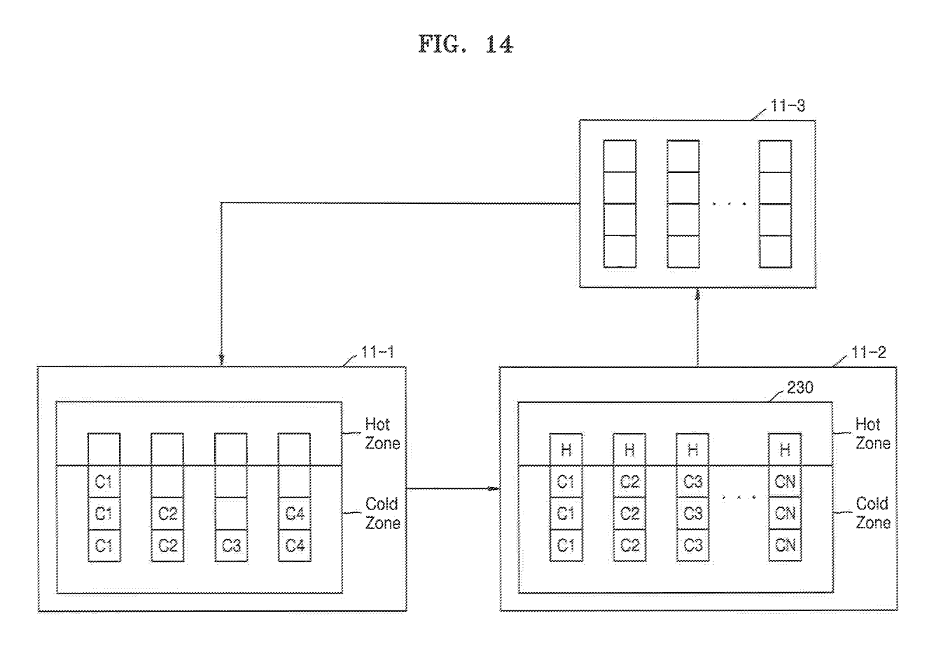

FIG. 14 is a conceptual diagram illustrating a relationship between memory blocks in the memory system 100 according to an exemplary embodiment of the present inventive concept. For example, FIG. 14 shows an one-way cycle how a free block changes to a data block through an active block, then returns to a new free block.

Referring to FIG. 14, the memory blocks of the memory device 10 may be classified as a data block, an active block, and a free block. The data block may refer to a memo block of which all pages are written. For example, the data block may refer to a block of which writable pages are all consumed. Accordingly, the data block has no empty pages to be written. The active block may refer to a memory block including at least one empty page and at least one written page. The active block may include at least one empty page to be written. The free block may refer to a memory block of which all pates are erased. The free block may refer to a block of which all of pages are empty.

Active blocks are included in an active block pool 11-1, and data blocks are included in a data block pool 11-2, and free blocks are included in a free block pool 11-3.

For example, referring to FIG. 14, four pages are included in a memory block for convenience of description, and a page corresponding to an uppermost word line is determined as a first storage area, and the other three pages are determined as a second storage area. The present inventive concept is not limited thereto. For example, five or more pages may be included in each memory block, and two or more pages may be determined as a first storage area for each block.

Cold data may be classified as one of a plurality of sub-cold levels C1 through CN based on an update frequency of the cold data. For example, C1 is a sub-cold level with the lowest update frequency, and CN is a sub-cold level with the highest update frequency. N is an integer of2or greater.

Hot data H is stored in the first storage area (a hot zone) of each data block included in the data block pool 11-2 according to a control of the memory controller 20. Cold data is prohibited from being stored in the first storage area. The first storage area includes at least one page. Cold data C1 through CN are stored in the second storage area (a cold zone) of each data block of the data block pool 11-2. Cold data belonging to the same sub-cold level are stored in the second storage area of each of data blocks. For example, cold data is stored in a second storage area of a data block designated as a sub-cold level of the cold data. The second storage area includes at least one page. Hot data may be stored in a cold zone of some data blocks. This will be described below.

According to a control of the memory controller 20, hot data H is stored in the first storage area (a hot zone) of each active block included in the active block pool 11-1. Cold data is prohibited from being stored in the first storage area. The first storage area includes at least one page. Also, cold data C1 through Ci are stored in the second storage area (a cold zone) of each active block. In the second storage area of each active block, cold data belonging to the same sub-cold level is stored in the second storage area of each of active blocks. For example, cold data is stored in the second storage area of an active block designed as a sub-cold level corresponding to the cold data. The second storage area includes at least one page. Hot data may be stored in a cold zone of some active blocks. This will be described below.

As illustrated in FIG. 14, if a page of the uppermost word line is determined as the first storage area, the page of the first storage area may be written last in each active block, If hot data is written to the first storage area in an active block, the active block turns to a data block. In this case, the block to which hot data is written to the first storage area thereof in the active block is moved from the active block pool 11-1 to the data block pool 11-2.

For example, if there is a write request with respect to cold data, and there is no active block with empty page in the second storage area among active blocks included in the active block pool 11-1, the memory controller 20 may select a free block included the free block pool 11-3 and write the cold data to the selected free block. In this case, the free block becomes an active block. The selected tree block is removed from the free block pool 11-3 and is included in the active block pool 11-1.

If there is no active block with an empty page in the second storage area storing data having the sub-cold level of cold data that is requested to be written, the memory controller 20 selects a free block. If an update frequency of the cold data to be written is equal to or greater than a predetermined frequency, a free block with the lowest programming/erase frequency among free blocks included in the free block pool 11-3 is selected. The selected free block is included in the active block pool 11-1.

If the number of free blocks included in the free block pool 11-3 is reduced to less than a predetermined number, the memory controller 20 may perform garbage collection to move a victim block selected from the data block pool 11-2 to the free block pool 11-3.

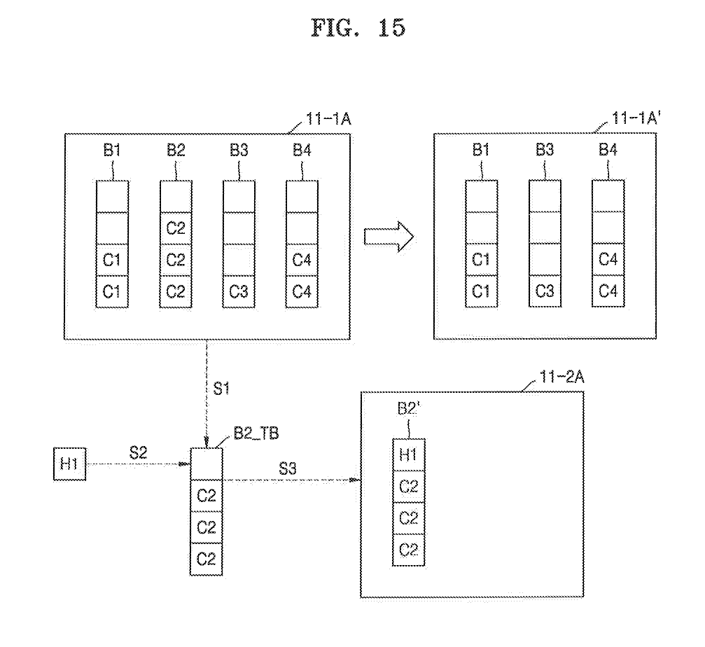

FIG. 15 is a conceptual diagram of memory blocks to illustrate a method of managing hot data in the memory system 100 according to an exemplary embodiment of the present inventive concept.

Referring to FIG. 15, it is assumed for the convenience of description that an active block pool 11-1 includes four blocks B1 through 134 in the memory device 10.

If a host issues a write request with respect to hot data H1 to the memory controller 20, the memory controller 20 searches for an active block with no empty page in a second storage area among the four active blocks B1 to B4 in the active block pool 11-1A. In this case, the active block B2 is selected, because it has no empty page in the second storage area. The memory controller 20 determines the active block B2 as a target active block B2_TB in operation S1.

The memory controller 20 controls the memory system 100 to write the hot data H1 to an empty page of a first storage area of the target active block B2_TB in operation S2.

When an operation of writing hot data HI requested to be written to an empty page of the first area of the active block B2 is completed, the active block 132 becomes a data block B2′ with not empty page. Thus, after the write operation with respect to the hot data H1 is completed, the data block B2′ becomes a data block, and thus the data block pool 11-2A includes the data block B2′ as a data block in operation S3. After the write operation of the hot data HI, the active block pool 11-1A becomes an active block pool 11-A′ including active blocks B1, B3 and B4 only.

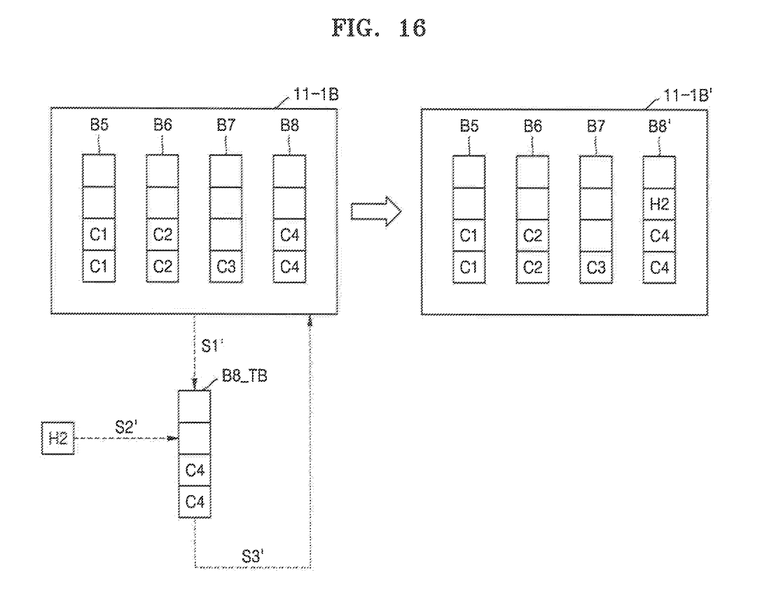

FIG. 16 is a conceptual diagram of memory blocks to illustrate a method of managing hot data in a memory system according to an exemplary embodiment of the inventive concept.

Referring to FIG. 16, it is assumed for the convenience of description that four active blocks B5 through B8 are in the active block pool 11-1B of the memory device 10.

If a host issues a write request with respect to hot data H2 to the memory controller 20, the memory controller 20 searches for an active block with no empty page in a second storage area. In this case, all the active blocks B5 to B8 includes at least one empty page in the second storage area, and thus the memory controller 20 further searches an active block storing data of the highest update frequency among the active blocks B5 to B8 for a target active block in operation S1′. In this case, the active block B8 stores data of the highest update frequency (the highest sub-cold level C4), and thus the memory controller 20 determines the active block B8 as a target active block B8_TB.

The memory controller 20 controls the memory system 100 to write the hot data H2. to an empty page of the second storage area of the target active block B8_TB in operation S2′. As described above, if a write request with respect to hot data is issued, and if there is no active block with data written to all pages of the second storage area, hot data may be written to the second storage area which is a cold zone in an active block storing data of the highest update frequency among available active blocks.

In this case, the target block B8_TB still includes an empty page in the first storage area (a hot zone), and thus the active block B8 remains in the active block pool 11-1B in operation S3′ after the hot data H2 is written to the second storage area. Accordingly, the active block pool 11-1B′ still includes, after the write operation, four blocks B5, B6, B7, and B8.

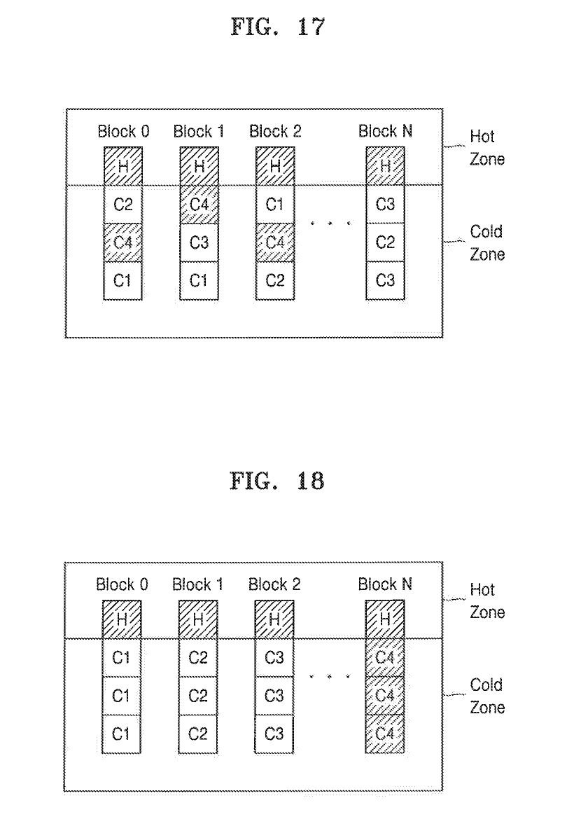

FIG. 17 illustrates an example where a victim block is determined in a garbage collection operation when cold zone leveling is not performed in a memory system according to an exemplary embodiment of the inventive concept. The cold zone leveling may refer to as a method of classifying cold data into a plurality of sub-cold level and storing data having the same sub-cold level into the same active block, as described with reference to FIGS. 14 to 16.

FIG. 18 illustrates an example where a victim block is determined in a garbage collection operation when cold zone leveling is performed in a memory system according to an exemplary embodiment of the inventive concept.

In FIGS. 17 and 18, data blocks BLOCK 0 through BLOCK N included in the data block pool 11-2 are illustrated. For the convenience of description, a single block is assumed to include four pages. Hatched pages denote invalid pages, and unhatched pages denote valid pages. If data stored in a page needs update in a flash memory, the page is invalidated and its updated data is stored in a different page, because the flash memory cannot perform an in-place overwrite operation. A page marked “H” is a page written with hot data, and pages marked “C1-C4” denote pages written with cold data. Also, an update frequency of cold levels increases in an order of C1→C2→C3→C4. For example, cold data of a page marked “C4” has the highest update frequency, and cold data of a page marked “C1” has the lowest update frequency.

First, an operation of determining a victim block in a garbage collection operation will be described with reference to FIG. 17.

Referring to FIG. 17, a write operation with respect to cold data is performed without performing cold zone leveling in the memory system, and thus, cold data having different sub-cold levels are stored together in the same cold zone for each data block. For a request for a garbage collection operation, a data block with the highest number of invalid pages is determined as a victim block. Referring to FIG. 17, blocks BLOCK 0, BLOCK 1, BLOCK 2 include two invalid pages from among the data blocks BLOCK 0 through BLOCK N. Accordingly, one of the data blocks BLOCK 0, BLOCK 1, BLOCK 2 is determined as a victim block. In this case, two valid pages exist in a data block selected as the victim block, and thus, garbage collection costs are increased. For example, the valid pages of a victim block need to be relocated to another block before the victim block is erased in the garbage collection operation.

Next, an operation of determining a victim block in a garbage collection operation will be described with reference to FIG. 18.

It is assumed that a data block includes data stored according to cold zone leveling in the memory system in FIG. 18. As such, data having the same sub-cold level is stored in the same block.

For a garbage collection operation, a data block with the highest number of invalid pages is determined as a victim block. Referring to FIG. 18, a block BLOCK N includes four invalid pages, which is the highest number of invalid pages, from among the data blocks. Accordingly, the block BLOCK N is determined as a victim block. in this case, the block BLOCK N has no valid page, and thus, garbage collection costs are minimized.

Accordingly, if a write operation with respect to cold data is performed using cold zone leveling, a garbage collection efficiency may increase.

The method of managing a storage area in the memory system according to flowcharts of FIGS. 19 through 24 and the write operation performed by using the processor 210 of the memory controller 20 illustrated in FIG. 13 and using the program codes and data stored in the RAM 220 will be described in detail.

FIG. 19 is a flowchart of a method of managing a storage area in the memory system 100 according to an exemplary embodiment of the inventive concept. First, in operation S110, the processor 210 converts a logical address of data that is requested to be written, to a physical address. For example, a logical address of hot data is converted to a physical address within a first storage area of a target block. Also, the processor 210 converts a logical address of cold data to a physical address within a second storage area of a target block. Accordingly, the processor 210 performs address conversion such that cold data is prohibited from being stored in the first storage area in a target block of the memory device 10.

Next, in operation S120, the processor 210 controls the memory device 10 to write data that is requested to be written to the physical address of the memory device 10 converted in operation S110. For example, the processor 210 issues a control signal, a command, and an address to the memory device 10 for a writing operation of the data requested to be written. The address issued by the processor 210 is the physical address of the memory device 10 obtained by the conversion in operation S110. Also, the data requested to be written is transmitted to the memory device 10.

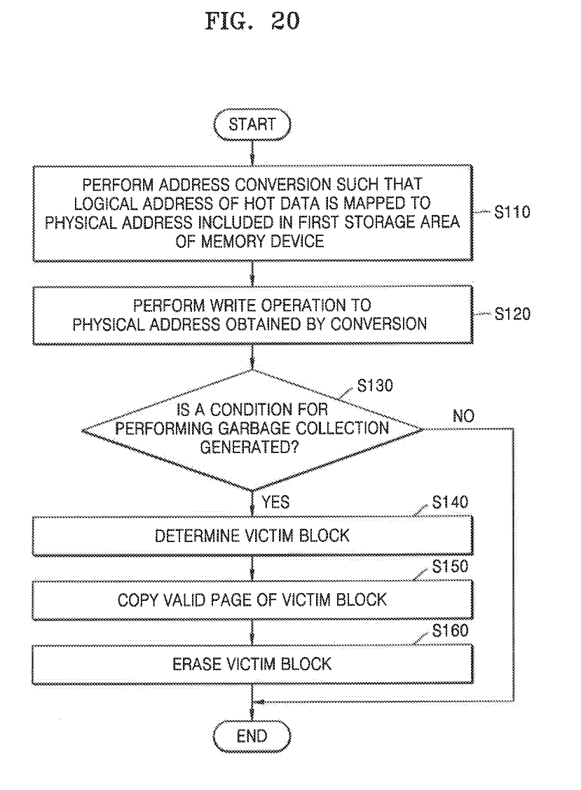

FIG. 20 is a flowchart of a method of managing a storage area in a memory system according to an exemplary embodiment of the present inventive concept.

Operations S110 and S120 are described above with reference to FIG. 19, and thus description thereof will not be repeated.

After performing operations S110 and S120, the processor 210 determines whether garbage collection is necessary, in operation S130. For example, if the number of free blocks is reduced to less than a predetermined number, garbage collection may be necessary to increase the number of free blocks.

In this case, the processor 210 determines one of data blocks as a victim block in operation S140. For example, the processor 210 may determine a data block including the highest number of invalid pages as a victim block.

In operation S150, the processor 210, if the victim block have valid pages, copies the valid pages of the victim block to an empty page of a first storage area or a second storage area of an active block based on the update frequency of the valid pages.

In operation S160, the processor 210 erases the victim block to generate a free block. For example, after performing an erasing operation with respect to the victim block, the processor 210 moves the erased victim block to a free block pool. The meaning of “move” may refer to as the processor 210 changing classification of a block using a Flash Translation Layer (FTL). However, the present inventive concept is not limited thereto, and such classification change may be performed in various manner.

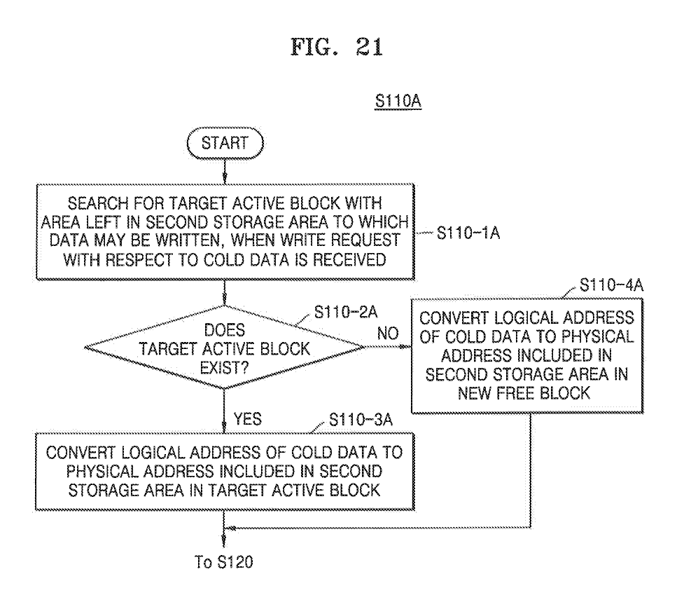

FIG. 21 illustrates an address conversion process of FIG. 19 or FIG. 20 for data classified as cold data, according to an exemplary embodiment of the present inventive concept.

In operation S110-1A, the processor 210 searches for a target active block to write cold data. An active block is a target active block if the active block includes an empty page in a second storage area. For example, the processor 210 searches through mapping table information stored in the RAM 220 to find whether an active block has an empty page in a second storage area.

In operation S110-2A, the processor 210 determines whether a target active block exists in an active block pool.

If there is a target active block after determining of operation S110-2A, the processor 210 converts a logical address of cold data requested to be written to a physical address within the second storage area of the target active block in operation S110-3A. For example, the processor 210 converts a logical address of cold data requested to be written, to a physical address of the second storage area in the target active block.

If there is no target active block as a result of determination of operation S110-2A, the processor 210 converts a logical address of cold data requested to be written, to a physical address within a second storage area in a free block in operation S110-4A. In this case, the processor 210 moves a free block included in a free block pool to an active block pool, and then converts a logical address of cold data requested to be written, to a physical address corresponding to an empty page in a second storage area of the free block moved to the active block pool.

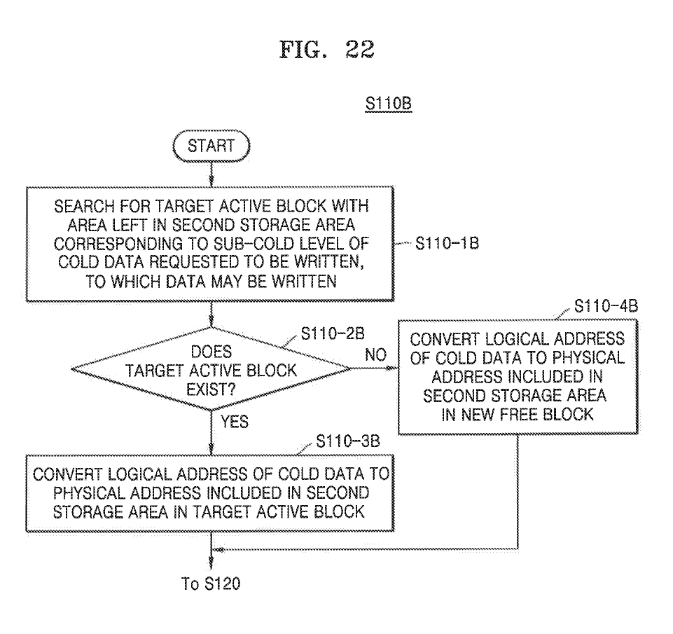

FIG. 22 illustrates an address conversion process of FIG. 19 or FIG. 20 for cold data, according to an exemplary embodiment of the present inventive concept.

In operation S110-1B, if there is a write request with respect to cold data, the processor 210 searches for a target active block with an empty page in a second storage area designated to a sub-cold level of cold data requested to be written, from among active blocks. For example, the processor 210 searches for a target active block with an empty page left in a second storage area corresponding to a sub-cold level of cold data requested to be written, from among active blocks included in an active block pool by using mapping table information stored in the RAM 220.

in operation S110-2B, the processor 210 determines whether a target active block exists in an active block pool.

If there is a target active block according to a result of determination of operation 8110-2B, the processor 210 converts a logical address of cold data requested to be written, to a physical address within a second storage area of the target active block in operation S110-3B. For example, the processor 210 converts a logical address of the cold data requested to be written, to a physical address corresponding to an empty page in the second storage area of the target active block.

If there is no target active block according to a result of determination of operation S110-2B, the processor 210 converts a logical address of cold data requested to be written, to a physical address included in a second storage area in a free block in operation S110-4B. For example, the processor 210 moves a free block included in a free block pool to an active block pool, and then converts a logical address of cold data requested to be written, to a physical address corresponding to an empty page in a second storage area of the free block moved to the active block pool. In an exemplary embodiment, the processor 210 assigns a free block with the lowest programming/erase frequency, from among free blocks, if an update frequency of cold data requested to be written is equal to or greater than a predetermined number, and converts a logical address of the cold data requested to be written, to a physical address included in the second storage area in the free block.

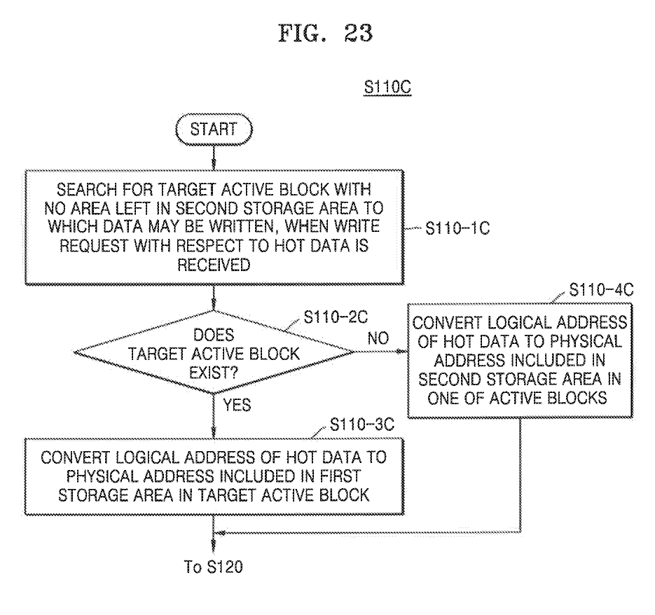

FIG. 23 illustrates an address conversion process of FIG. 19 or FIG. 20 performed on hot data according to an exemplary embodiment of the present inventive concept.

In operation S110-1C, for a write request with respect to hot data, the processor 210 searches for a target active block with no empty pages in a second storage area from among active blocks. For example, the processor 210 searches for a target active block in which the second storage area has no empty pages and the first storage area has at least one empty page among active blocks included in an active block pool by using mapping table information stored in the RAM 220.

In operation S110-2C, the processor 210 determines whether a target active block exists in an active block pool.

If there is a target active block according to a result of determination of operation S110-2C, the processor 210 converts a logical address of cold data requested to be written, to a physical address included in a first storage area in a target active block in operation S110-3C. For example, the processor 210 converts a logical address of hot data requested to be written, to a physical address corresponding to an empty page in the first storage area of the target active block.

if there is no target active block according to a result of determination of operation S110-2C, the processor 210 converts a logical address of hot data requested to be written, to a physical address included in a second storage area in one of active blocks in operation S110-4C. For example, the processor 210 may convert a logical address of hot data requested to be written, to a physical address corresponding to an empty page in a second storage area of an active block having a second storage area with the highest update frequency.

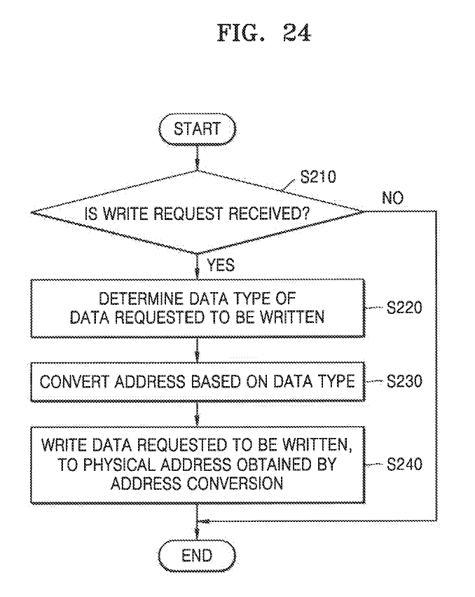

FIG. 24 is a flowchart of a write operation in a memory system according to an exemplary embodiment of the inventive concept.

In operation S210, the processor 210 determines whether a write request is received from a host. For example, the processor 210 determines whether a write command is received from the host through the host interface 240.

When a write command is received, the processor 210 determines a data type of data requested to be written, in operation S220. The processor 210 determines data requested to be written as hot data or cold data based on an update frequency. For example, data with an update frequency equal to or greater than a predetermined value may be determined as hot data, and data with an update frequency less than the predetermined value may be determined as cold data. Alternatively, if data is updated before a predetermined time, the data may be determined as hot data, and if data is updated after the predetermined time, the data may be determined as cold data. Also, hot data or cold data may he determined by predicting an update frequency according to a file attribute. For example, data predicted to have a high update frequency based on a file extension may be determined as hot data, and other data may be determined as cold data. Also, the processor 210 may classify cold data into one of multiple sub-cold levels based on an update frequency of the cold data. Alternatively, a data type of data to be written may be determined by a host, and the processor 210 of the memory controller 20 may determine a data type based on information about a determination result transmitted from the host.

In operation S230, the processor 210 performs address conversion based on a data type of data requested to be written, in operation S230. For example, the processor 210 may perform address conversion as in operation S110 of FIG. 19, for example.

In operation S240, the processor 210 performs an operation of writing data requested to be written, to a physical address that is address-converted. For example, the processor 210 may control the memory device 10 to perform a write operation as in operation S120 of FIG. 19, for example.

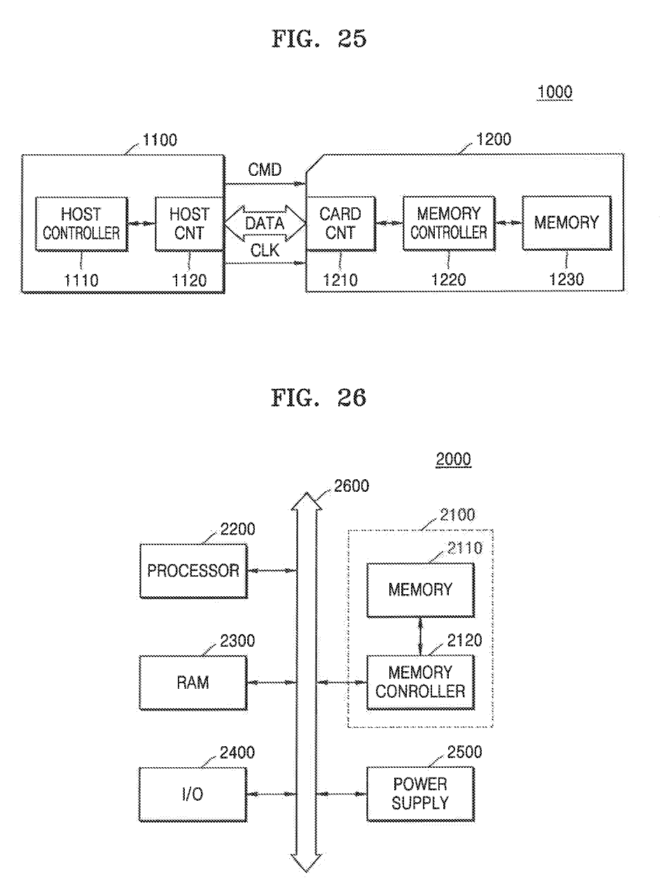

FIG. 25 is a block diagram of a memory card system 100 including a memory system according to an exemplary embodiment of the present inventive concept.

Referring to FIG. 25, the memory card system 1000 includes a host 1100 and a memory card 1200. The host 1100 includes a host controller 1110 and a host connection unit 1120. The memory card 1200 includes a card connection unit 1210, a memory controller 1220, and a memory device 1230. The memory controller 1220 and the memory device 1230 may have the same configuration as the memory controller 20 and the memory device 10 of FIG. 1, respectively.

The host 1100 may write data to the memory card 1200 or read data stored in the memory card 1200, The host controller 1110 may transmit a command CMD, a clock signal CLK generated by a clock generator (not shown) in the host 1100, and data DATA to the memory card 1200 via the host connection unit 1120.

The memory controller 1220 may store data in the memory device 1230 in synchronization with a clock signal generated by a dock generator (not shown) in the memory controller 1220 in response to a command received through the card connection unit 1210. The memory device 1230 may store data transmitted from the host 1100.

The memory card 1230 may be, for example, a compact flash card (CFC), a Microdrive, a smart media card (SMC), a multimedia card (MMC), a security digital card (SDC), a memory stick, or a universal serial bus (USB) flash memory driver.

FIG. 26 is a block diagram illustrating a computing system 2000 including a memory system according to an exemplary embodiment of the present inventive concept.

Referring to FIG. 26, the computing system 2000 includes a memory system 2100, a processor 2200, a RAM 2300, an input/output device 2400, and a power supply 2500.

The memory system 2100 includes a memory device 2110 and a memory controller 2120. The memory device 2110 and the memory controller 2120 may have the same configuration as the memory device 10 and the memory controller 20 of FIG. 1, respectively.

The computing system 2000 may further include ports through which the computing system 2000 may communicate with a video card, a sound card, a memory card, or a USB device, or other electronic devices. The computing system 2000 may be, for example, a personal computer or a portable electronic device such as a laptop computer, a mobile phone, a personal digital assistant (PDA), or a camera.

The processor 2200 may perform predetermined computations or tasks. According to an exemplary embodiment, the processor 2200 may be a micro-processor or a CPU. The processor 2200 may perform communication with the RAM 2300, the input/input device 2400, and the memory system 2100 through a bus 2600 such as an address bus, a control bus, or a data bus. According to an exemplary embodiment, the processor 2200 may be connected to an extension bus such as a peripheral component interconnect (PCI) bus.

The RAM 2300 may store data necessary for an operation of the computing system 2000. For example, the RAM 2300 may be a DRAM, a mobile DRAM, an SRAM, a PRAM, an FRAM, an RRAM, and/or MRAM.

The input/output device 2400 may include an input unit such as a keyboard, a keypad, or a mouse and an output unit such as a printer or a display. The power supply 2500 may supply an operating voltage for an operation of the computing system 2000.

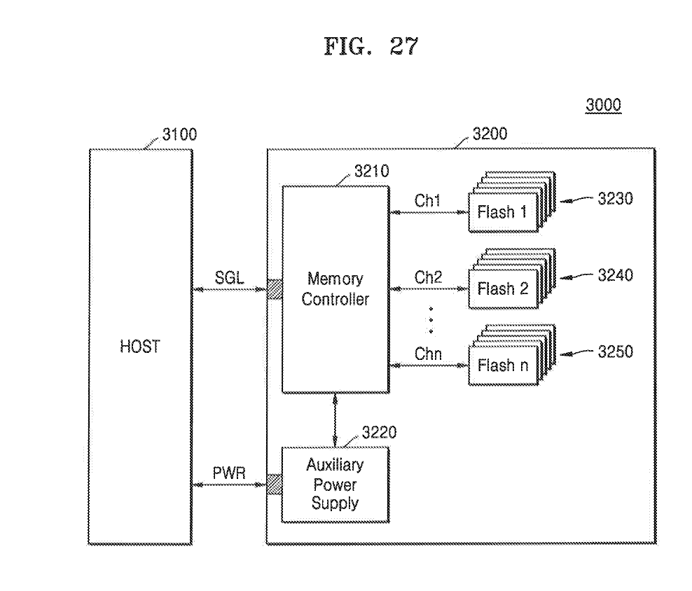

FIG. 27 is a block diagram illustrating a memory system according to embodiments of the inventive concept applied to a solid state drive (SSD) system 3000.

Referring to FIG. 27, the SSD system 3000 includes a host 3100 and an SSD 3200. The SSD 3200 transmits or receives a signal with the host 3100 via a signal connector, and receives power via a power connector. The SSD 3200 includes a memory controller 3210, an auxiliary power supply 3220, and a plurality of memory devices 3230, 3240, and 3250. The memory controller 3210 and the plurality of memory devices 3230, 3240, and 3250 may have the same configuration as the memory controller 20 and the memory device 10 of FIG. 1, respectively.

The embodiments of the inventive concept may be implemented as a method, an apparatus or a system. When implemented as software, elements of the inventive concept are code segments that execute necessarily needed operations. Programs or code segments may be stored in a processor readable medium. A processor readable medium may include any medium that may store information. Examples of readable media include an electronic circuit, a semiconductor memory device, a read only memory (ROM), a flash memory, an erasable ROM (FROM), a floppy disk, an optical disk, and a hard disk.

While the present inventive concept has been shown and described with reference to exemplary embodiments thereof, it will be apparent to those of ordinary skill in the art that various changes in form and detail may be made therein without departing from the spirit and scope of the inventive concept as defined by the following claims.

What is claimed is:

1. A method of managing a storage area of a memory device in a memory system, the method comprising:
receiving a first data having a logical address to be written to the memory device having a plurality of memory blocks;
classifying the first data into one of a hot data and a cold data based on an update frequency of the first data;
defining a first storage area and a second storage area of a memory block of the plural of memory blocks based on an amount of charge loss of a memory cell in the memory block, wherein a memory cell of the first storage area has charge loss greater than a memory cell of the second storage area;
converting the logical address of the first data to a physical address of the memory device according to a result of the classifying of the first data; and
writing the first data to a memory cell having the physical address of the memory device.

2. The method of claim 1, wherein the memory device includes a flash memory device.

3. The method of claim 2, wherein if the flash memory device comprises a three-dimensional vertical NAND flash memory device, the first storage area and the second storage area of each memory block are divided by a predetermined word line, the first storage area of each memory block includes memory cells connected to the predetermined word line or memory cells connected to word lines that are above the predetermined word line, and the second storage area of each memory block includes memory cells connected to word lines that are below the predetermined word line.

4. The method of claim 1, wherein if the flash memory device comprises a planar NAND flash memory device, the first storage area and the second storage area of each memory block are divided by a first predetermined word line and a second predetermined word line, the first storage area includes memory cells connected to word lines below the first predetermined word line or memory cells connected to word lines above the second predetermined word line, and the second storage area includes memory cells connected to the first predetermined word lines, memory cells connected to the second predetermined word lines or memory cells connected to word lines disposed between the first and the second predetermined word lines.

5. The method of claim 1, wherein the converting of the logical address to the physical address comprises:
if the first data is classified as the cold data, mapping the logical address of the cold data to the physical address within a second storage area of an active block.

6. The method of claim 1, wherein the classifying of the first data into one of the hot data and cold data comprises:
if the first data is classified as the cold data, classifying the cold data into a plurality of sub-cold levels based on the update frequency of the first data,
wherein the converting of the logical address of the first data to the physical address comprises:
is if the first data is classified as the cold data, mapping the logical address of the first data having the same sub-cold level to a physical address within a second storage area of the same active block of the memory device.

7. The method of claim 6, wherein the converting of the logical address of the first data to the physical address further comprises:
searching for an active block of which a second storage area includes at least one pages written with data having the same sub-cold level as the first data and at least one empty pages;
if the active block, exists according to a result of the searching for the active block, mapping the logical address of the first data to the physical address within the second storage area of the active block; and
if the active block does not exist according to a result of the searching, mapping the logical address of the first data to the physical address within a second storage area of a first free block.

8. The method of claim 7, wherein the first free block is a free block having a lowest programming/erase frequency among free blocks if the update frequency of the first data is equal to or greater than a predetermined number.

9. The method of claim 5, wherein the converting of the logical address of the first data to the physical address further comprises:
searching for the active block;
mapping the logical address of the first data to the physical address within a second storage area of the active block if the active block exists according to a result of the searching; and
mapping the logical address of the first data to the physical address within a second storage area in a free block if the active block does not exist as a result of the searching.

10. The method of claim 1, wherein if the first data is classified as the hot data, the converting of the logical address of the first data to the physical address includes:
searching for first active block, wherein the first active block has no empty pages in a second storage area of the first active block and at least one pages in a first storage area of the first active block;
if the first active block exists according to a result of the searching, mapping the logical address of the first data to the physical address within the first storage area of the first active block; and
if the first active block does not exist according to a result a the searching,
mapping the logical address of the first data to the physical address within a second storage area of a second active block having at least one empty pages in a second storage area of the second active block.

11. The method of claim 10, wherein the first active block is an active block having a second storage area storing data having a sub-cold level of a highest update frequency.

12. The method of claim 1, further comprising performing a garbage collection operation,
wherein the performing of the garbage collection comprises:
selecting a victim block from a plurality of data blocks, wherein each data block includes no empty pages to be written and the victim block is a data block having a highest number of invalid pages among the plurality of data blocks;
copying a valid page to an empty page of an active block based on an update frequency of data stored in the valid page; and
generating a free block by erasing the victim block,
wherein the copying comprises copying a valid page storing a hot data to a first storage area of the active block.

13. A memory system comprising:
a memory device including a plurality of memory blocks, wherein each block includes a first storage area including a first memory cell and a second storage area including a second memory cell; and
a memory controller configured to classify data to be written to the memory device into one of a hot data and a cold data based on an update frequency of the data,
wherein the first storage area and the second storage area are determined based on an amount of charge loss of the first and second memory cells according to time, wherein the amount of charge loss of the first memory cell is greater than the amount of charge loss of the second memory cell.

14. The memory system of claim 13, wherein the memory controller is further configured to:
classify, if the data is classified into the cold data, the cold data into one of a plurality of sub-cold levels based on the update frequency of the data, and
control the memory device such that the cold data belonging to a same sub-cold level is written to a second storage area of a same memory block.

15. The memory system of claim 13, wherein the memory controller comprises:
a data type determining unit configured to classify the data into one of the hot data and the cold data based on the update frequency of the data, and further configured to classify the data, if the data is classified into the cold data, into one of a plurality of sub-cold levels based on the update frequency of the data;
a cold data managing unit configured to:
designate a sub-cold level to a first active block of the memory device; and
control the memory device such that the cold data is written to a second storage area of the first active block of a sub-cold level cold data; and
a hot data managing unit configured to control the memory device such that the hot data is written to a first storage area in a second active block having no empty pages in a second storage area of the second active block and at least one empty page in a first storage area of the second active block.

16. The memory system of claim 13, wherein the memory device comprises a three dimensional memory array.

17. The memory system of claim 21, wherein the three dimensional memory array comprises a non-volatile memory that is monolithically formed in one or more physical levels of memory cells having active areas disposed above a silicon substrate.

18. The memory system of claim 21, wherein the three dimensional memory array comprises a plurality of memory cells, each of the memory cells including a charge trap layer.

19. The memory system of claim 21, wherein word lines and/or bit lines in the three-dimensional memory array are shared between levels.

20. A method of managing a storage area of a memory device in a memory system, the method comprising:
classifying a first data to be written to the storage area into one of a hot data and a cold data based on a predetermined criteria;
defining a first storage area and a second storage area of a memory block of the plurality of memory blocks according to locations of a plurality of memory cells in the memory block;
if a first result of the classifying of the first data indicates to a cold data, writing the first data into the second storage area of the memory block; and
if a second result of the classifying of the first data indicates a hot data and if the memory block has an empty page in the first storage area and has no empty pages in the second storage, writing the first data into the first storage area of the memory block.

21. The method of claim 20, further comprising:
if the second result indicates to the cold data and if the memory block has an empty page in the second storage area, writing the first data into the second storage area of the memory block.

22. The method of claim 20, wherein if the first result indicates to the cold data and if the second storage area of the memory block has no empty page, writing the first data to a free block.

23. The method of claim 20, wherein a number of the free block is greater than 1, selecting a free block having a lowest programming/erase frequency.

24. The method of claim 20, further comprising:
classifying the cold data into a plurality of sub-cold levels according to the update frequency of the first data; and
designating a sub-cold level to the memory block,
wherein the writing of the first data into the second storage area comprise: writing the first data so that the memory block designated with the sub-cold level stores the first data having the same sub-cold level as the sub-cold level designated to the memory block.
